(19) United States
(12) Patent Application Publication
(10) Pub. No.: US 2024/0209262 A1
(43) Pub. Date: Jun. 27, 2024

(54) COMPOUND HAVING THERMOTROPIC LIQUID CRYSTALLINE STRUCTURE, AND POLYETHYLENE GLYCOL POLYMER THEREOF

(71) Applicant: KYUNGPOOK NATIONAL UNIVERSITY INDUSTRY-ACADEMIC COOPERATION FOUNDATION, Daegu (KR)

(72) Inventors: Hyeon Uk YEO, Daegu (KR); So Yeong CHOE, Daegu (KR); Kyo Sun KU, Daegu (KR); Ye Ji HAN, Daegu (KR)

(73) Assignee: KYUNGPOOK NATIONAL UNIVERSITY INDUSTRY-ACADEMIC COOPERATION FOUNDATION, Daegu (KR)

(21) Appl. No.: 18/286,082

(22) PCT Filed: Apr. 5, 2022
(86) PCT No.: PCT/KR2022/004891

§ 371 Date: Oct. 6, 2023

(30) Foreign Application Priority Data
Apr. 7, 2021 (KR) 10-2021-0045178
Apr. 4, 2022 (KR) 10-2022-0041487

(51) Int. Cl. C09K 19/12; C08G 65/26; C09K 19/20; C09K 19/34

(52) U.S. Cl. CPC C09K 19/12; C08G 65/26; C09K 19/2007; C09K 19/3411; C09K 2019/122; C09K 2019/2035; C09K 2019/3413

(57) ABSTRACT

There are provided a compound having a thermotropic liquid crystalline structure and a polyethylene glycol polymer. The compound is obtained by modifying an epoxide functional group in a thermotropic liquid crystalline molecule. The polyethylene glycol polymer is obtained by ring-opening polymerization thereof. The polyethylene glycol main chain polymer is easy to form in thin film, bulk, or fiber form, and has a high thermal conductivity and thus can be used alone or in the form of a composite material as a heat-dissipating polymer.

### CROSS-REFERENCE TO PRIOR APPLICATIONS

This application is a National Stage Patent Application of PCT International Application No. PCT/KR2022/004891 (filed on Apr. 5, 2022), which claims priority to Korean Patent Application Nos. 10-2021-0045178 (filed on Apr. 7, 2021) and 10-2022-0041487 (filed on Apr. 4, 2022), which are all hereby incorporated by reference in their entirety.

### BACKGROUND

The present invention relates to: a compound having a thermotropic liquid crystalline structure and obtained by modifying an epoxide functional group in a thermotropic liquid crystalline molecule; and a polyethylene glycol polymer obtained by ring-opening polymerization thereof, and more specifically, to a polyethylene glycol main chain polymer that is easy to form in thin film, bulk, or fiber form, and has a high thermal conductivity and thus can be used alone or in the form of a composite material as a heat-dissipating polymer.

Liquid crystalline polymer (LCP) is a polymer that exhibits a liquid crystalline phase in a molten or solution state and generally has a structure containing a mesogenic unit. Thermotropic liquid crystalline polymer (TLCP) exhibits liquid crystal behavior according to changes of the temperature, and its properties significantly vary depending on the position, shape, and structure of the mesogenic unit. Since it exhibits excellent mechanical properties in addition to high heat resistance and chemical resistance, it is applicable to fields such as high-performance composites and engineering plastics, and much research has been conducted both academically and industrially.

However, previously reported thermotropic liquid crystal polymers have the disadvantage of having to be synthesized and processed at a high temperature or in a solution state of strong acids and organic solvents due to their high melting temperature and chemical resistance. Most liquid crystal polymers are synthesized by using solvents, and are representatively detailed in U.S. patent Ser. No. 04/954,606, U.S. patent Ser. No. 05/109,100, and U.S. patent Ser. No. 04/912,193. In this case, there is the disadvantage that a process for removing a solvent should be gone through after preparing a liquid crystal polymer, and at the same time, there is the disadvantage that processing in a molten state is difficult. To lower the polymerization and processing temperature, methods such as placing a bulky molecule in a side chain or introducing a long flexible chain into a main chain are used. These conventional technologies include Journal of Polymer Science Part A: Polymer Chemistry, Vol. 19, (8), 1901 (1981); Macromolecular Chemistry and Physics, Vol. 192, (2), 201 (1991); Polymer Journal, Vol. 17, (1), 105 (1985); Polymer, Vol. 32, (9), 1703 (1991); Polymer Preprint (American Chemical Society), Vol. 27, (1), 369 (1986): Polymer Journal, Vol. 17, (1), 277 (1985); and Journal of Polymer Science Part A: Polymer Chemistry, Vol. 21, (11), 3313 (1983). However, there are limitations that deterioration of performance occurs to a certain extent at the polymerization and processing temperature of any of these structures; new processes or input of reactants result in an increase of the cost; and an additional process must be carried out to process the prepared liquid crystal polymer.

Therefore, to solve the above-mentioned problems, the present inventor recognized that the development of a compound having a thermotropic liquid crystal structure and a polyethylene glycol polymer thereof was urgently needed to develop a thermoplastic liquid crystal polymer that is easy to form, and thus completed the present invention.

### SUMMARY

The object of the present invention is to provide a compound having a thermotropic liquid crystal structure and obtained by modifying an epoxide functional group in a thermotropic liquid crystal molecule; and a polyethylene glycol polymer obtained by ring-opening polymerization thereof.

Another object of the present invention is to provide a polyethylene glycol polymer that is easy to form in thin films, bulk, and fiber form, and has high thermal conductivity, and thus can be used as a heat-dissipating polymer and a composite material.

The technical problems to be achieved by the invention are not limited to the technical problems mentioned above, and other technical problems that are not mentioned can be clearly understood by those skilled in the art from the description of the present invention.

To achieve the objects described above, the present invention provides a compound having a thermotropic liquid crystal structure in a side chain, represented by Formula (I) below.

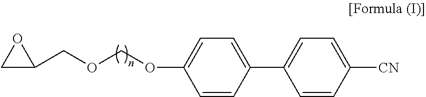

[In the formula, n is an integer in a range from 1 to 30.]

The present invention provides a compound having a thermotropic liquid crystal structure in a side chain, represented by Formula (II) below.

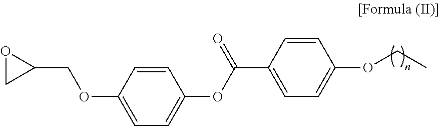

[In the formula, n is an integer in a range from 1 to 30.]

The present invention provides a polyethylene glycol polymer obtained by ring-opening polymerization of a compound represented by Formula (I) above.

The present invention provides a polyethylene glycol polymer obtained by ring-opening polymerization of a compound represented by Formula (II) above.

In addition, the present invention provides a polyethylene glycol polymer represented by Formula (III) below and obtained by ring-opening polymerization of a compound represented Formula (I) or Formula (II) above

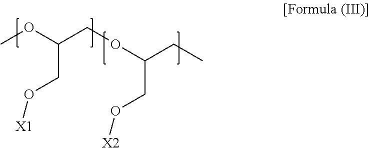

[In the formula, X1 and X2 may be the same or different and are selected from the compound according to claim 1 or the compound according to claim 2].

The polyethylene glycol polymer can be used as a general-purpose material mainly for various electronic components such as substrates, compounds, adhesives, pads, heat spreads, and heat sinks.

All matters that are mentioned above regarding the compound having a thermotropic liquid crystal structure and the polyethylene glycol polymer thereof apply equally unless contradictory.

The novel polyethylene glycol polymer prepared according to the present invention is easy to form in thin film, bulk, and fiber form and has improved thermal conductivity so that it can be applied to various electronic components.

The effects of the present invention are not limited to the effects mentioned above, and other effects that are not mentioned will be clearly understood by those skilled in the art from the description of the claims.

### BRIEF DESCRIPTION OF THE DRAWINGS

FIGS. 1A-1F are ¹H-NMR spectrums of EPCNn (4-(n-(oxiran-2-ylmethoxy) alkyloxy)-4-biphenylcarbonitrile) synthesized according to an embodiment of the present invention (FIG. 1A: EPCN4, FIG. 1B: EPCN5, FIG. 1C: EPCN6, FIG. 1D: EPCN7, FIG. 1E: EPCN8, and FIG. 1F: EPCN9).

FIGS. 2A-2F are ¹³C-NMR spectrums of EPCNn (FIG. 2A: EPCN4, FIG. 2B: EPCN5, FIG. 2C: EPCN6, FIG. 2D: EPCN7, FIG. 2E: EPCN8, and FIG. 2F EPCN9).

FIGS. 3A-3F are ¹H-NMR spectrums of P-EPCNn synthesized according to another embodiment of the present invention (FIG. 3A: P-EPCN4, FIG. 3B: P-EPCN5, FIG. 3C: P-EPCN6, FIG. 3D: P-EPCN7, FIG. 3E: P-EPCN8, and FIG. 3F P-EPCN9).

FIG. 4 is an FT-IR spectrum of the P-EPCNn.

FIGS. 5A-5F show the results of gel permeation chromatography (GPC) analysis of the P-EPCNn.

FIG. 6 is a phase transition diagram analyzed by differential scanning calorimetry (DSC).

FIGS. 7A-7F are DSC analysis graphs of the EPCNn analyzed at a heating and cooling rate of 2° C./min (FIG. 7A: EPCN4, FIG. 7B: EPCN5, FIG. 7C: EPCN6, FIG. 7D: EPCN7, FIG. 7E: EPCN8, and FIG. 7F: EPCN9).

FIG. 8 is a polarized optical microscope (POM) image of the EPCNn (scale bar=50 μm).

FIG. 9 is a DSC analysis graph of the P-EPCNn analyzed at a heating and cooling rate of 5° C./min.

FIG. 10 is a POM image of the P-EPCNn (scale bar=50 μm).

FIG. 11 is a bulk specimen of P-EPCNn prepared for thermal conductivity evaluation.

FIG. 12 is an X-ray diffraction analysis (XRD) graph of P-EPCNn at room temperature.

FIG. 13 shows an optimized molecular structure of the P-EPCNn model compound calculated by the density functional theory (DFT) at the B3LYP/6-31G level.

FIGS. 14A-14D are ¹H-NMR spectrums of OMPBn (4-(oxiran-2-ylmethoxy) phenyl 4-alkoxybenzoate) synthesized according to another embodiment of the present invention (FIG. 14A: OMPB4, FIG. 14B: OMPB6, FIG. 14C: OMPB8, and FIG. 14D: OMPB10).

FIGS. 15A-15D are ¹³C-NMR spectrums of OMPBn (FIG. 15A: OMPB4, FIG. 15B: OMPB6, FIG. 15C: OMPB8, and FIG. 15D: OMPB10).

FIGS. 16A-16D are ¹H-NMR spectrums of P-OMPBn synthesized according to another embodiment of the present invention (FIG. 16A: P-OMPB4, FIG. 16B: P-OMPB6, FIG. 16C: P-OMPB8, and FIG. 16D: P-OMPB10.

### DETAILED DESCRIPTION

The terms used in this specification are selected from general terms that are currently widely used as much as possible while considering the function in the present invention, but these may vary depending on the intention or precedent of those skilled in the art, the emergence of new technology, and the like. In addition, in certain cases, there are terms arbitrarily selected by the applicant, and in these cases, the meaning will be described in detail in the relevant description of the invention. Therefore, the terms used in the present invention should be defined based on the meaning of the terms and the overall content of the present invention, rather than simply the names of the terms.

Unless otherwise defined, all terms used herein, including technical or scientific terms, have the same meaning as commonly understood by one of ordinary skill in the technical field to which the present invention pertains. Terms defined in commonly used dictionaries should be interpreted as having meanings consistent with the meanings they have in the context of the related technology, and unless clearly defined in the present application, should not be interpreted in an idealized or excessively formal sense.

The numerical range includes the values defined in the range. Any maximum numerical limit given throughout this specification includes all lower numerical limits as if the lower numerical limit were clearly written. Every minimum numerical limit given throughout this specification includes every higher numerical limit as if such higher numerical limit were clearly written. All numerical limits given throughout this specification will include all better numerical ranges within the broader numerical range, as if the narrower numerical limits were clearly written.

Hereinafter, the present invention will be described in detail.

The present invention provides a compound having a thermotropic liquid crystal structure in a side chain, represented by Formula (I) below.

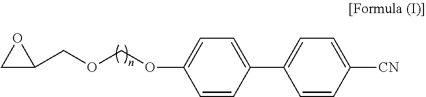

[In the formula, n is an integer in a range from 1 to 30.]

The compound of Formula (I) above may be synthesized by using 4-hydroxy-4-biphenylcarbonitrile as a starting material and subjecting the same to a reaction with dibromoalkane to synthesize 4-(4-bromoalkoxy)-4-biphenylcarbonitrile (4-(4-bromoalkoxy)-4-biphenylcarbonitrile, BRCNn), and then using 4-(4-bromoalkoxy)-4-biphenylcarbonitrile again as an initiating material to synthesize the compound through a reaction with glycidol.

The compound may be 4-(n-(oxiran-2-ylmethoxy) alkyloxy)-4-biphenylcarbonitrile.

The preparation of the compound of Formula (I) above may be carried out under basic conditions, for example, in the presence of sodium hydroxide.

In the preparation of the compound of Formula (I) above, dimethylformamide (DMF), N-methylpyrilidone (NMP), N, N′-dimethylacetamide (DMAc), dimethylsulperoxide (DMSO), tetrahydrofuran (THF), metacresol (m-cresol), or mixtures thereof may be used as a solvent.

The reaction for preparing the compound of Formula (I) above may be carried out at a temperature in a range from 20 to 45° C., preferably at a temperature in a range from 30 to 45° C.

The preparation time of the compound of Formula (I) above may be in a range from 36 hours to 48 hours, preferably in a range from 36 hours to 42 hours.

The present invention provides a compound having a thermotropic liquid crystal structure in a side chain, represented by Formula (II) below.

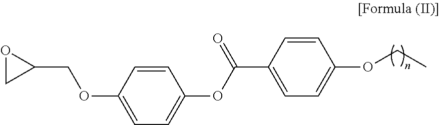

[In the formula, n is an integer in a range from 1 to 30.]

The compound of Formula (II) above may be synthesized by using 4-(alkoxy) benzoic acid as a starting material and subjecting the same to a reaction with hydroquinone to synthesize 4-hydroxyphenyl 4-alkoxybenzoate (HPBn), and then using 4-hydroxyphenyl 4-alkoxybenzoate as an initiating material to synthesize the compound through a reaction with epichlorohydrin.

The compound may be 4-(oxiran-2-ylmethoxy) phenyl 4-butoxybenzoate.

The preparation of compounds of Formula (II) above may be carried out under basic conditions, for example, in the presence of sodium hydroxide.

The reaction for preparing the compound of Formula (II) above may be carried out at a temperature in a range from 65 to 95° C., preferably at a temperature in a range from 70 to 85° ° C.

The preparation time of the compound of Formula (II) may be in a range from 0.5 hours to 4 hours, preferably in a range from 0.5 hours to 2 hours.

The present invention provides a polyethylene glycol polymer obtained by ring-opening polymerization of a compound having a thermotropic liquid crystal structure in a side chain, represented by Formula (I) above.

The present invention provides a polyethylene glycol polymer obtained by ring-opening polymerization of a compound having a thermotropic liquid crystal structure in a side chain, represented by Formula (II) above.

In addition, the present invention provides a polyethylene glycol polymer represented by Formula (III) below and obtained by ring-opening polymerization of a compound having a thermotropic liquid crystal structure according to Formula (I) or (II) above.

The ring-opening polymerization may be any one selected from anionic ring-opening polymerization, cationic ring-opening polymerization, and radical ring-opening polymerization, but is not limited thereto.

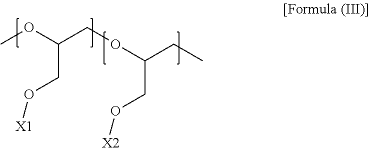

[In the formula, X1 and X2 may be the same or different and are selected from the compound according to claim 1 or the compound according to claim 2].

Formula (III) above may be a homopolymer or a copolymer.

The ring-opening polymerization may be performed in the presence of an initiator, wherein the initiator may be a metal alkoxide such as potassium tert-butoxide, lithium tert-butoxide, sodium tert-butoxide, potassium ethoxide, aluminum butoxide, and aluminum isopropoxide, and an initiator commonly known to those skilled in the art may be used.

The ring-opening polymerization may be carried out in the presence of a catalyst, wherein the catalyst may be a catalyst such as 18-crown-6 ether, 15-crown-5 ether, dibenzo-18-crown-6, dicyclohexyl-18-crown-6, and tetramethyl ammonium chloride (TMAC), and a catalyst commonly known to those skilled in the art may be used.

The ring-opening polymerization may be performed in the presence of a solvent, wherein the solvent may be a solvent such as toluene, cyclohexane, hexane, heptane, xylene, and ethylbenzene, and a solvent commonly known to those skilled in the art may be used.

In the ring-opening polymerization, an initiator may be included in an amount of 1 to 45 parts by weight, preferably 5 to 45 parts by weight, and more preferably 10 to 45 parts by weight, based on 100 parts by weight of the total monomers.

When the initiator is added in an amount less than 1 part by weight, there may be a problem of non-polymerization, and when the initiator is added in more than 45 parts by weight, there may be a problem of generating of low-molecular weight polymers.

In the ring-opening polymerization, a catalyst may be included in an amount of 0.1 to 15 parts by weight, preferably 0.5 to 15 parts by weight, and more preferably 1 to 15 parts by weight, based on 100 parts by weight of total monomers.

When the catalyst is added in an amount less than 0.1 part by weight, problems of non-polymerization or reaction rate reduction may occur, and when the catalyst is added in an amount more than 15 parts by weight, there may be a problem of generating of low-molecular weight polymers.

The ring-opening polymerization may be performed at a temperature in a range from 50 to 70° C., and preferably at a temperature in a range from 55 to 65° C.

The ring-opening polymerization may be performed for 72 to 84 hours, and preferably for 72 to 80 hours.

The ring-opening polymerization may be performed under non-reactive gas conditions, wherein the non-reactive gas may be helium, argon, or nitrogen, preferably argon or nitrogen, and most preferably argon.

After the ring-opening polymerization, the polymerization solution may be precipitated in an alcohol.

The alcohol may be an alcohol such as methanol, ethanol, propanol, isopropanol, butanol, pentanol, hexanol, and heptanol, and an alcohol commonly known to those skilled in the art may be used.

The precipitation may be performed 2 to 5 times, preferably 2 to 4 times.

The polyethylene glycol polymer of Formula (III) above may have a thermal conductivity of 0.30 (W/m·K) or more, for example, in a range from 0.30 to 0.45 (W/m·K).

The polyethylene glycol polymer of Formula (III) above may have a glass transition temperature of 10° C. or higher, for example, it may have a glass transition temperature in a range of 10 to 60° C., and preferably, it may have a glass transition temperature in a range of 10 to 55° C.

The polyethylene glycol polymer of Formula (III) above may have a melting point of 85° C. or higher, for example, it may have melting point in a range of 85 to 200° C., and preferably, it may have melting point in a range of 88 to 200° C.

The polyethylene glycol polymer of the present invention can be used in the electronics industry as, for example, substrates, compounds, adhesives, pads, heat spreads, and heat sinks.

Hereinafter, the present invention will be described in detail through examples to aid understanding. However, the following examples only illustrate the content of the present invention and the scope of the present invention is not limited to the examples described below. Examples of the present invention are provided to more completely explain the present invention to those skilled in the art.

### <Materials Used and Analytical Methods>

### 1. Materials Used

4-hydroxy-4-biphenylcarbonitrile and six types of dibromoalkanes were purchased from TCI (Japan). Potassium carbonate, anhydrous toluene, 18-crown-6, and potassium tert-butoxide were obtained from Alfa Aesar (USA). General chemicals such as magnesium sulfate and sodium hydroxide and general organic solvents were purchased from Duksan and Daejung Chemicals (Korea). Anhydrous toluene, anhydrous acetone, anhydrous DMF, and silica gel were purchased from Wako Pure Chemical (Japan). All chemicals were used without further purification, and all reactions were carried out in argon (Ar) atmosphere.

### 2. Analytical Methods

The chemical structure of the synthesized materials was determined by ¹H NMR (500 MHZ) and ¹³C NMR (125 MHz) using a nuclear magnetic resonance spectrometer (NMR, AVANCE III 500, Bruker) at the Instrumental Analysis Center at Kyungpook National University by using CDCl3 or DMSO-d₆ as a solvent, and tetramethylsilane (TMS) was used as an internal reference material.

To investigate the functional groups of the synthesized polymer, Fourier-transform infrared spectroscopy (FT-IR, FT/IR-4100, Jasco) was performed, and high-resolution mass spectra (HRMS) were obtained from the Daegu Center of the Korea Basic Science Institute.

Thermal properties, including phase transition behavior, were investigated by differential scanning calorimetry (DSC, Q2000, TA Instruments and DSC4000, PerkinElmer) in N₂ atmosphere. Approximately 5.0 mg of a sample was used for DSC measurement, and an empty aluminum pan was used as a reference. The heating and cooling rate for DSC measurements was 2° C. or 5° C. per minute, and it was confirmed that there was no critical difference through the measurement repeated in at least two cycles.

Mesomorphic properties were analyzed by using a polarizing optical microscope (POM, BX53M, Olympus) with a Linkam stage (LTS420). For POM observation, an LC (liquid crystal) cell having a thickness of 20 μm was used and manufactured as described below.

A glass plate (2.5×2.5 cm²) and a washed glass plate (7.0×5.0 cm²) were washed by ultrasonic cleaning in three consecutive stages by using water, distilled water, and 2-propanol containing 1.0 wt % of a neutral detergent. After drying the plate surface at 120° C. for 1 hour, a pair of glass plates were assembled with a spacer and an epoxy adhesive to construct an LC cell having a cell gap of 20 μm. An LC material was injected into the cell by capillary force in an LC state.

The molecular weight of the polymer was determined by gel permeation chromatography (GPC, AS-4050, Jasco) using 50 mM LiBr eluent and dimethylformamide (DMF) and corrected with polystyrene (PS).

Thermal conductivity (TC) was recorded by using a TC measurement system (TPS 3500S, Hot Disk) with circular specimens (diameter: 10 mm, thickness: approximately 3 mm).

The microstructure of the polymer in a bulk state was investigated by using an X-ray diffractometer (XRD, Empyrean, Malvern Panalytical).

### <Example 1> EPCNn: Synthesis of 4-(n-(oxiran-2-ylmethoxy)alkyloxy)-4-biphenylcarbonitrile monomer

Scheme 1 below shows the synthesis process of the epoxide monomer EPCNn, which has cyanobiphenyl, a thermotropic liquid crystal structure, on a side chain, wherein 4-hydroxy-4-biphenylcarbonitrile was used as a starting material to synthesize BRCNn through a reaction with dibromoalkane, and then EPCNn was obtained through a reaction with glycidol.

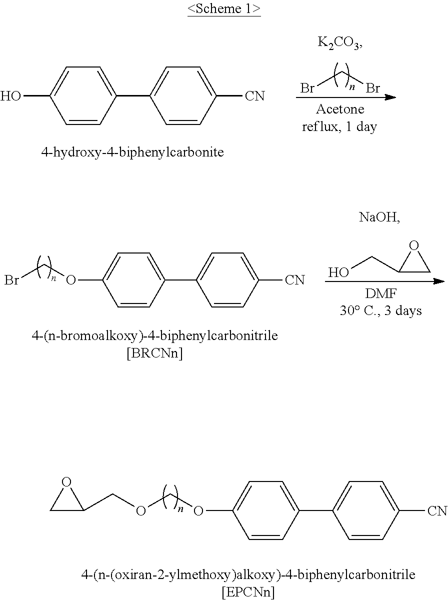

### \textcircled{1} Synthesis of BRCNn: 4-(4-bromoalkoxy)-4-biphenylcarbonitrile

A) n=4 (BRCN4)

Potassium carbonate (3.19 g, 23.1 mmol) and 4-hydroxy-4-biphenylcarbonitrile (3.00 g, 15.4 mmol) were put into a three-necked round flask, of which atmosphere was then replaced with argon, and 45 ml of acetone was added to dissolve the solute. Afterwards, 1,4-dibromobutane (2.80 ml, 23.1 mmol) was added to the flask, and the resulting mixture was stirred at 60° C. for 24 hours. The obtained material was extracted by using diethyl ether, and the organic phase was dried with magnesium sulfate and purified through silica column chromatography using a solution containing hexane and ethyl acetate in a volume ratio of 8:1 as an eluent. The yield was 57%.

¹H NMR (500 MHZ, CDCl₃): δ=7.70 (d, J=8.5 Hz, 2H), 7.65 (d, J=8.5 Hz, 2H), 7.51 (d, J=9.0 Hz, 2H), 7.00 (d), J=8.5 Hz, 2H), 4.07 (t, J=6.0 Hz, 2H), 3.52 (t, J=6.5 Hz, 2H), 2.13-2.08 (m, 2H), 2.01-1.96 (m, 2H) ppm.

B) n=5 (BRCN5)

The material was synthesized by the same procedure as A), except that 1,5-dibromopentane was used. The yield was 42%.

¹H NMR (500 MHZ, CDCl₃): δ=7.70 (d, J=8.5 Hz, 2H), 7.65 (d, J=8.5 Hz, 2H), 7.54 (d, J=9.0 Hz, 2H), 7.00 (d), J=8.5 Hz, 2H), 4.04 (t, J=6.5 Hz, 2H), 3.47 (t, J=7.0 Hz, 2H), 1.99-1.93 (m, 2H), 1.88-1.83 (m, 2H), 1.69-1.64 (m, 2H) ppm.

C) n=6 (BRCN6)

The material was synthesized by the same procedure as A), except that 1,6-dibromohexane was used. The yield was 53%.

¹H NMR (500 MHZ, CDCl₃): δ=7.70 (d, J=9.0 Hz, 2H), 7.65 (d, J=8.5 Hz, 2H), 7.54 (d, J=9.0 Hz, 2H), 7.00 (d), J=8.5 Hz, 2H), 4.03 (t, J=6.0 Hz, 2H), 3.45 (t, J=7.0 Hz, 2H), 1.93-1.90 (m, 2H), 1.85-1.82 (m, 2H), 1.53-1.52 (m, 4H) ppm.

D) n=7 (BRCN7)

The material was synthesized by the same procedure as A), except that 1,7-dibromoheptane was used. The yield was 24%.

¹H NMR (500 MHz, CDCl₃): δ=7.63 (d, J=8.5 Hz, 2H), 7.58 (d, J=8.5 Hz, 2H), 7.47 (d, J=9.0 Hz, 2H), 6.93 (d), J=9.0 Hz, 2H), 3.95 (t, J=6.5 Hz, 2H), 3.37 (t, J=6.5 Hz, 2H), 1.91-1.79 (m, 4H), 1.51-1.40 (m, 6H) ppm.

E) n=8 (BRCN8)

The material was synthesized by the same procedure as A), except that 1,8-dibromoheptane was used. The yield was 34%.

¹H NMR (500 MHZ, CDCl₃): δ=7.70 (d, J=9.0 Hz, 2H), 7.65 (d, J=8.5 Hz, 2H), 7.54 (d, J=9.0 Hz, 2H), 7.00 (d), J=9.0 Hz, 2H), 4.02 (t, J=6.5 Hz, 2H), 3.43 (t, J=6.5 Hz, 2H), 1.90-1.79 (m, 4H), 1.53-1.34 (m, 8H) ppm.

F) n=9 (BRCN9)

The material was synthesized by the same procedure as A), except that 1,9-dibromoheptane was used. The yield was 51%.

¹H NMR (500 MHZ, CDCl₃): δ=7.70 (d, J=8.5 Hz, 2H), 7.50 (d, J=8.5 Hz, 2H), 7.54 (d, J=9.0 Hz, 2H), 7.00 (d), J=8.5 Hz, 2H), 4.02 (t, J=6.5 Hz, 2H), 3.43 (t, J=6.5 Hz, 2H), 1.89-1.78 (m, 4H), 1.51-1.31 (m, 10H) ppm.

### \textcircled{2} Synthesis of EPCNn: 4-(n-(oxiran-2-ylmethoxy) alkyloxy)-4-biphenylcarbonitrile

G) n=4 (EPCN4)

The BRCN4 (1.94 g, 5.87 mmol) and sodium hydroxide (0.352 g, 8.81 mmol) were put into a three-necked round flask, of which atmosphere was then replaced with argon. Afterwards, glycidol (1.00 ml, 11.6 mmol) and 35.0 ml of dimethylformamide were added. The reaction was carried out at 30° C. for 3 days, and the obtained material was extracted by using ethyl acetate, dried with magnesium sulfate, and purified through silica column chromatography using a solution containing hexane and ethyl acetate in a volume ratio of 4:1 as an eluent. The yield was 51%. Identification of the materials was performed through 1H NMR, 13C NMR, and high-resolution mass spectrometry, and the analysis results are described below.

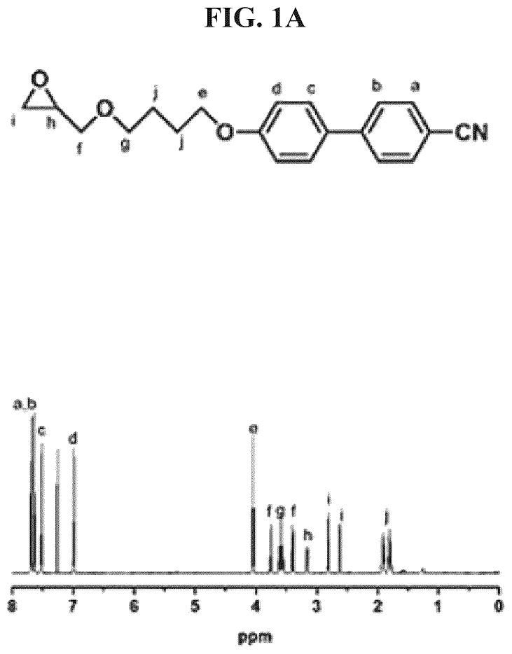

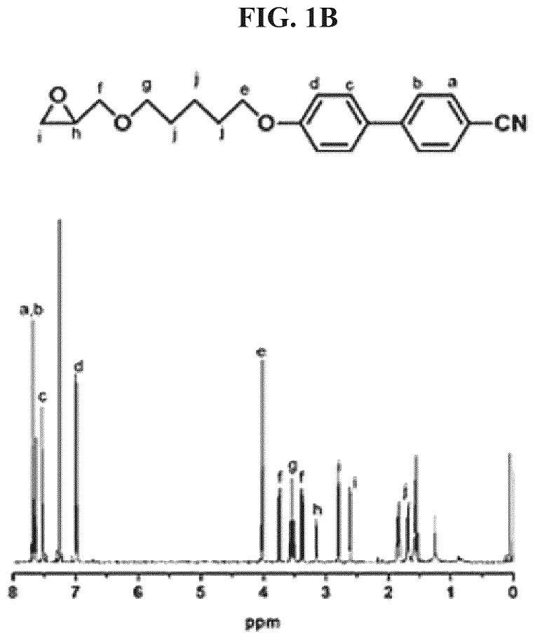

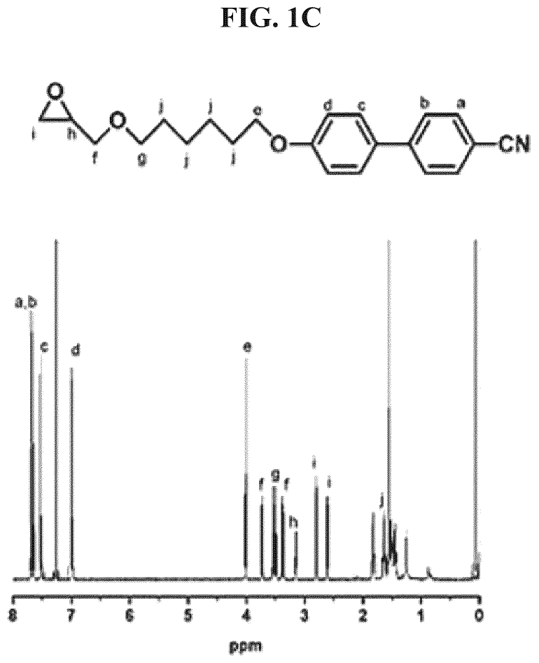

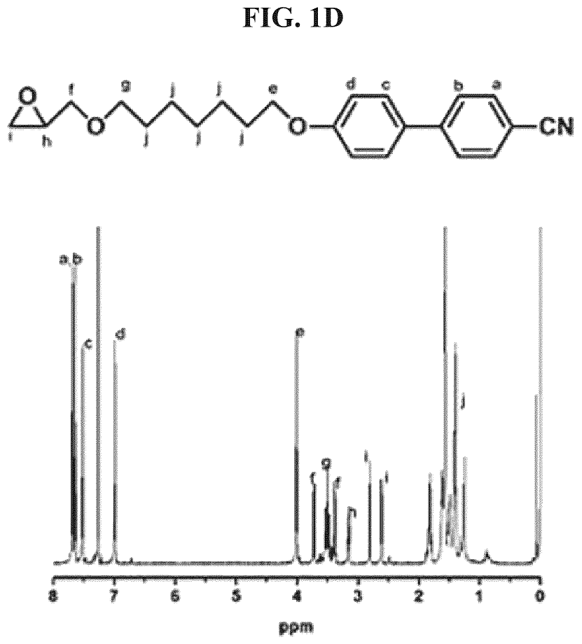

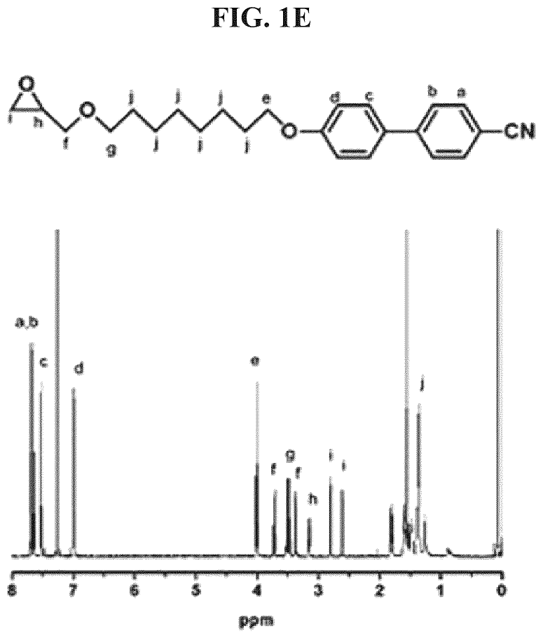

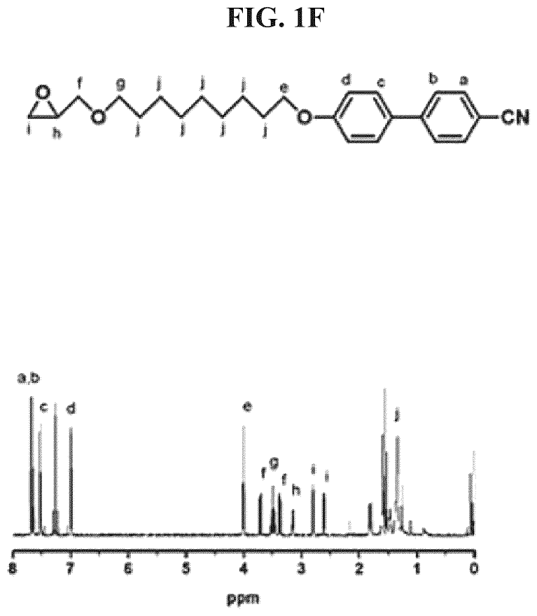

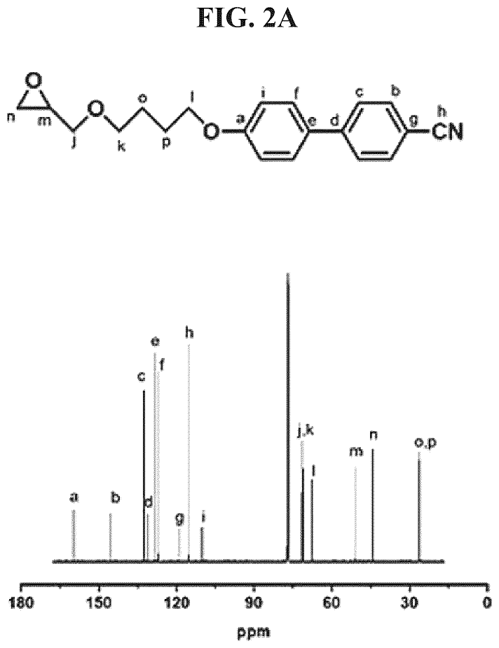

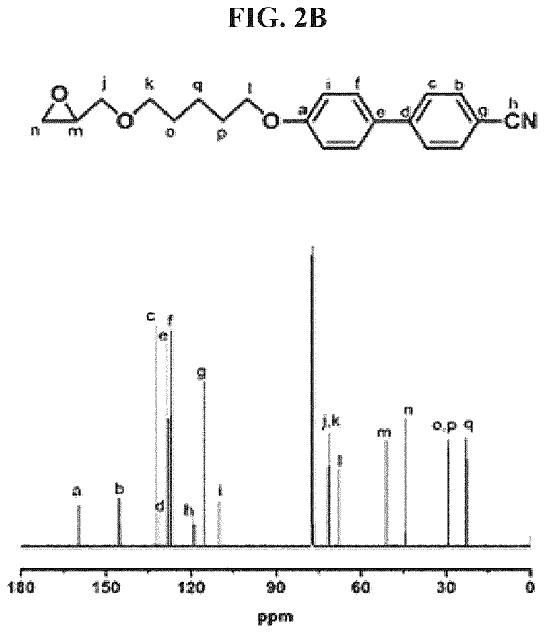

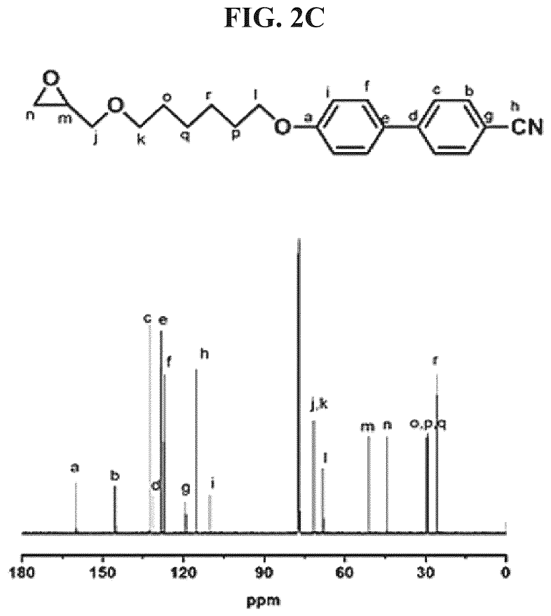

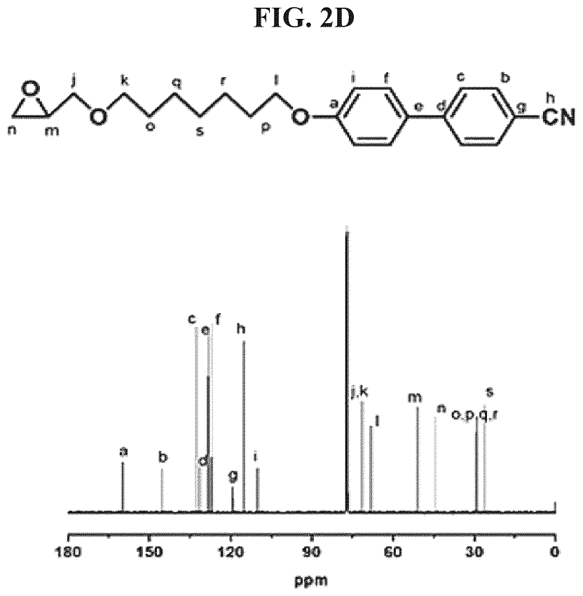

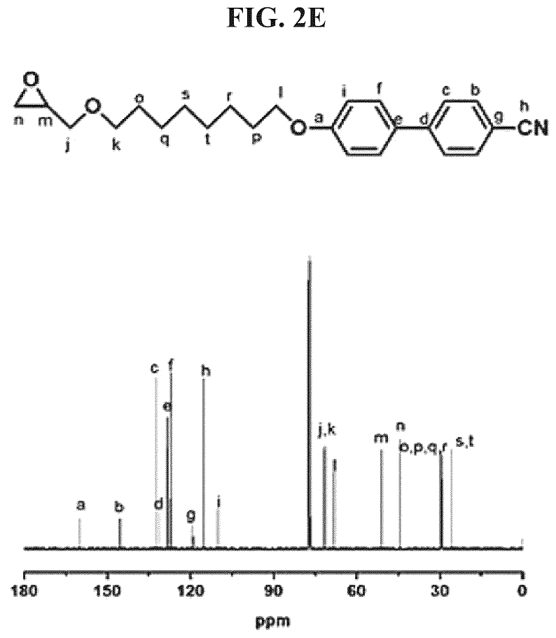

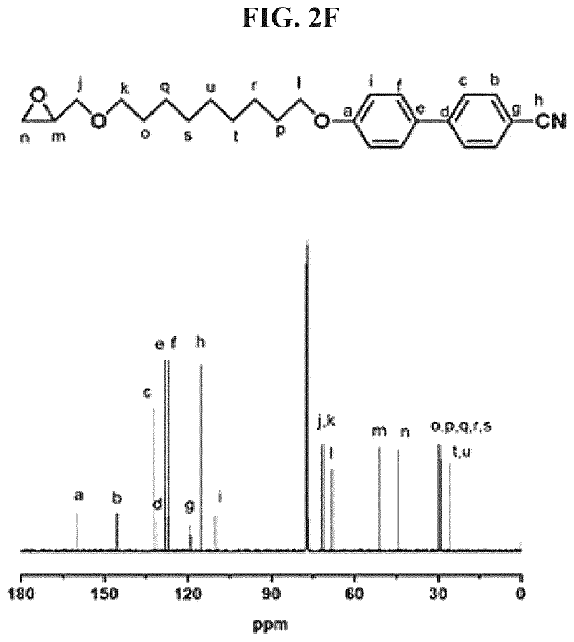

¹H NMR (500 MHZ, CDCl₃): δ=7.70 (d, J=8.5 Hz, 2H), 7.65 (d, J=8.5 Hz, 2H), 7.53 (d, J=8.5 Hz, 2H), 6.99 (d), J=8.5 Hz, 2H), 4.04 (t, J=6.5 Hz, 2H), 3.77 (dd, J=11.5, 3 Hz, 1H), 3.60 (m, 2H), 3.39 (dd, J=11.5, 6 Hz, 1H), 3.16 (m, 1H), 2.80 (dd, J=5, 4.5 Hz, 1H), 2.61 (dd, J=5, 3 Hz, 1H), 1.90 (m, 2H), 1.81 (m, 2H) ppm. 13C NMR (125 MHZ, CDCl₃): δ=159.7, 145.3, 132.6, 131.4, 128.3, 127.1, 119.1, 115.1, 110.1, 71.5, 71.1, 67.8, 50.9, 44.2, 26.3, 26.0 ppm. HRMS (+EI): calcd for [C₂₀H₂₁NO₃]⁺: m/z 323.1521; found: m/z 323.1522 (FIG. 1A and FIG. 2A).

H) n=5 (EPCN5)

The material was synthesized by the same procedure as G), except that the BRCN5 was used. The yield was 35%.

¹H NMR (500 MHZ, CDCl₃): δ=7.70 (d, J=8.5 Hz, 2H), 7.65 (d, J=8.5 Hz, 2H), 7.53 (d, J=9 Hz, 2H), 6.99 (d), J=9 Hz, 2H), 4.02 (t, J=6 Hz, 2H), 3.77 (dd, J=11.5, 3 Hz, 1H), 3.55 (m, 2H), 3.40 (dd, J=11.5, 6 Hz, 1H), 3.15 (m, 1H), 2.80 (dd, J=5, 4 Hz, 1H), 2.62 (dd, J=5, 2.5 Hz, 1H), 1.84 (m, 2H), 1.68 (m, 2H), 1.56 (m, 2H) ppm. 13C NMR (125 MHz, CDCl₃): δ=159.7, 145.3, 132.6, 131.3, 128.3, 127.1, 119.1, 115.1, 110.0, 71.6, 71.4, 68.0, 50.9, 44.3, 29.5, 2 9.0, 22.7 ppm. HRMS (+EI): calcd for [C₂₁H₂₃NO₃]⁺: m/z 337.1678; found: m/z 337.1680 (FIG. 1B and FIG. 2B).

I) n=6 (EPCN6)

The material was synthesized by the same procedure as G), except that the BRCN6 was used. The yield was 47%.

¹H NMR (500 MHZ, CDCl₃): δ=7.70 (d, J=8.5 Hz, 2H), 7.65 (d, J=8 Hz, 2H), 7.53 (d, J=8.5 Hz, 2H), 6.99 (d), J=9 Hz, 2H), 4.01 (t, J=6.5 Hz, 2H), 3.74 (dd, J=11.5, 3 Hz, 1H), 3.52 (m, 2H), 3.38 (dd, J=11.5, 6 Hz, 1H), 3.15 (m, 1H), 2.80 (dd, J=5, 4.5 Hz, 1H), 2.61 (dd, J=5, 3 Hz, 1H), 1.82 (m, 2H), 1.64 (m, 2H), 1.50 (m, 4H) ppm. 13C NMR (125 MHz, CDCl₃): δ=159.8, 145.3, 132.6, 131.3, 128.3, 127.1, 119.1, 115.1, 110.0, 71.5, 71.5, 68.0, 50.9, 44.3, 29.6, 29.7, 25.9 ppm. HRMS (+EI): calcd for [C₂₂H₂₅NO₃]⁺: m/z 351.1834; found: m/z 351.1832 (FIG. 1C and FIG. 2C).

J) n=7 (EPCN7)

The material was synthesized by the same procedure as G), except that the BRCN7 was used. The yield was 33%.

¹H NMR (500 MHZ, CDCl₃): δ=7.70 (d, J=9 Hz, 2H), 7.65 (d, J=8.5 Hz, 2H), 7.53 (d, J=9 Hz, 2H), 6.99 (d), J=8.5 Hz, 2H), 4.00 (t, J=6.5 Hz, 2H), 3.73 (dd, J=11.5, 3 Hz, 1H), 3.51 (m, 2H), 3.39 (dd, J=11.5, 5.5 Hz, 1H), 3.14 (m, 1H), 2.80 (dd, J=5, 4 Hz, 1H), 2.61 (dd, J=5, 2.5 Hz, 1H), 1.81 (m, 2H), 1.61 (m, 2H), 1.50 (m, 2H), 1.39 (m, 4H) ppm. 13C NMR (125 MHz, CDCl₃): δ=159.8, 145.3, 132.6, 131.3, 128.3, 127.1, 119.1, 115.1, 110.0, 71.6, 71.5, 68.1, 50.9, 44.3, 29.6, 2 9.2, 29.1, 26.0, 25.9 ppm. HRMS (+EI): calcd for [C₂₃H₂₇NO₃]⁺: m/z 365.1991; found: m/z 365.1992 (FIG. 1D and FIG. 2D).

K) n=8 (EPCN8)

The material was synthesized by the same procedure as G), except that the BRCN8 was used. The yield was 44%.

¹H NMR (500 MHZ, CDCl₃): δ=7.70 (d, J=8 Hz, 2H), 7.65 (d, J=8.5 Hz, 2H), 7.53 (d, J=8.5 Hz, 2H), 6.99 (d), J=9 Hz, 2H), 4.00 (t, J=6.5 Hz, 2H), 3.73 (dd, J=11.5, 3 Hz, 1H), 3.50 (m, 2H), 3.39 (dd, J=11.5, 5.5 Hz, 1H), 3.15 (m, 1H), 2.80 (dd, J=5, 4.5 Hz, 1H), 2.61 (dd, J=5, 3 Hz, 1H), 1.80 (m, 2H), 1.60 (m, 2H), 1.47 (m, 2H), 1.36 (m, 6H) ppm. 13C NMR (125 MHZ, CDCl₃): 0=159.8, 145.3, 132.6, 131.3, 128.3, 127.1, 119.1, 115.1, 110.0, 71.7, 71.5, 68.1, 50.9, 44.3, 29.7, 29.4, 29.3, 29.2, 26.0, 25.9 ppm. HRMS (+EI): calcd for [C₂₄H₂₉NO₃]⁺: m/z 379, 2147; found: m/z 379.2145 (FIG. 1E and FIG. 2E).

L) n=9 (EPCN9)

The material was synthesized by the same procedure as G), except that the BRCN9 was used. The yield was 38%.

¹H NMR (500 MHZ, CDCl₃): δ=7.70 (d, J=8.5 Hz, 2H), 7.65 (d, J=8.5 Hz, 2H), 7.53 (d, J=9 Hz, 2H), 6.99 (d), J=8.5 Hz, 2H), 4.00 (t, J=6.5 Hz, 2H), 3.72 (dd, J=11.5, 3 Hz, 1H), 3.50 (m, 2H), 3.37 (dd, J=11.5, 6 Hz, 1H), 3.15 (m, 1H), 2.79 (dd, J=5, 4 Hz, 1H), 2.61 (dd, J=5, 2.5 Hz, 1H), 1.80 (m, 2H), 1.59 (m, 2H), 1.47 (m, 2H), 1.33 (m, 8H) ppm. 13C NMR (125 MHZ, CDCl₃): 0=159.8, 145.3, 132.6, 131.3, 128.3, 127.1, 119.1, 115.1, 110.0, 71.7, 71.5, 68.2, 50.9, 44.3, 29.7, 29.5, 29.4, 29.3, 29.2, 26.1, 26.0 ppm. HRMS (+EI): calcd for [C₂₅H₃₁NO₃]⁺: m/z 393.2304; found: m/z 393.2304 (FIG. 1F and FIG. 2F).

### <Example 2> Synthesis of EPCNn Polymer (P-EPCNn)

Scheme 2 below shows the synthesis process of P-EPCNn, a polyethylene glycol derivative having a liquid crystal structure of cyanobiphenyl in a side chain. As shown in Scheme 2 below, it was synthesized through anionic ring-opening polymerization of epoxide monomer EPCNn to form the polyethylene glycol main chain.

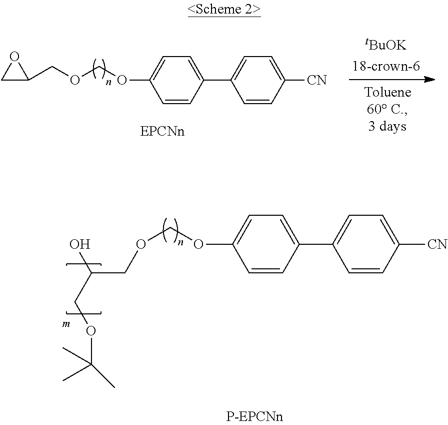

A) n=4 (P-EPCN4)

EPCN4 (1.34 mmol), potassium tert-butoxide (50.5 mg, 500 μmol), and 18-crown-6 (28.0 mg, 100 μmol) were added to a Schlenk tube, of which atmosphere was replaced with argon, Afterwards, 3 ml of toluene was added. The polymerization solution was stirred at 60° C. for 3 days, and then poured into 50 ml of methanol to precipitate, and the precipitate was recovered. The precipitation process was repeated twice, and a pale yellow solid was obtained with a yield of 61%.

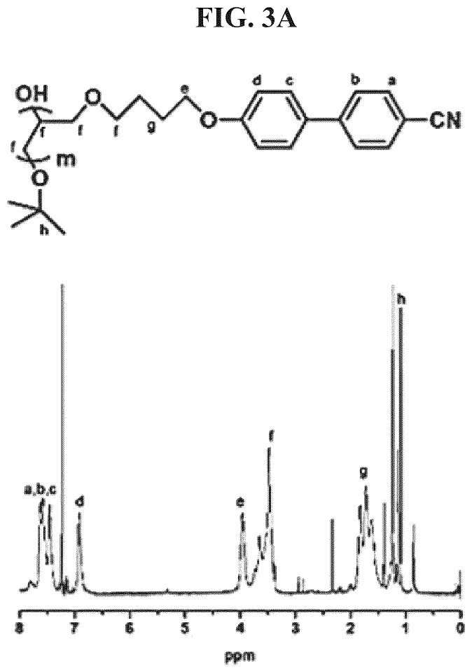

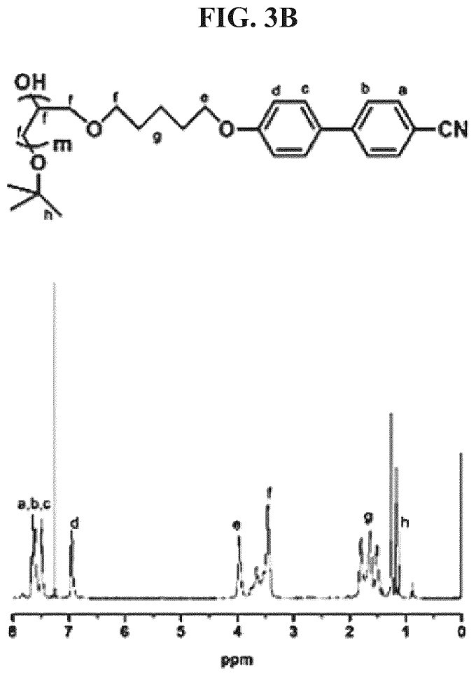

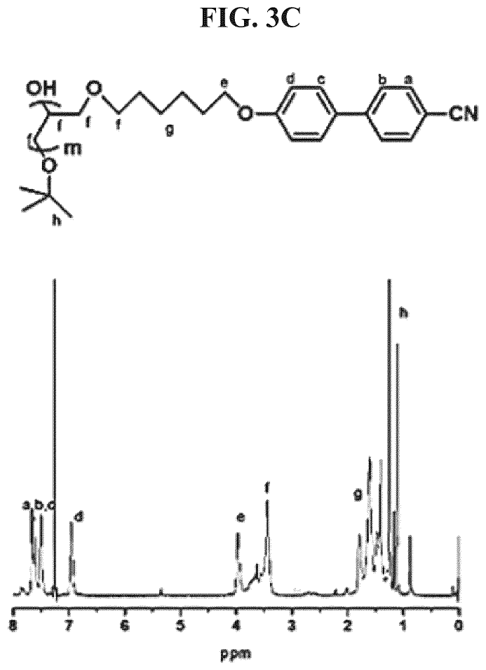

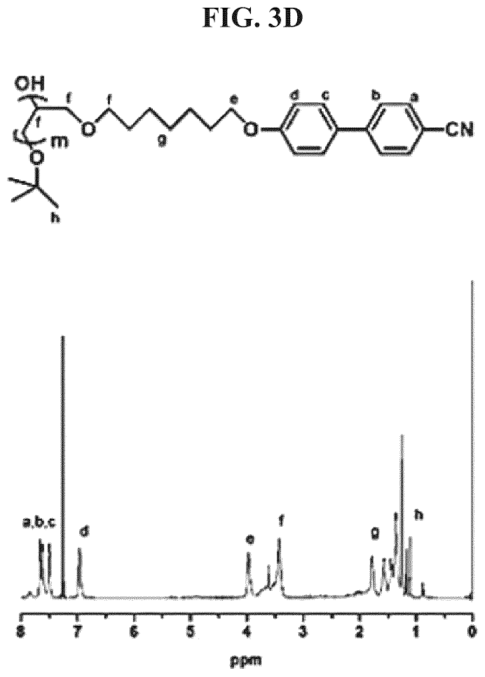

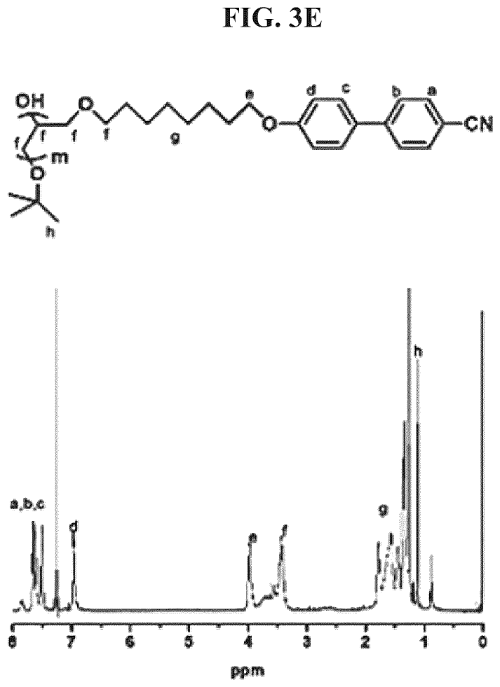

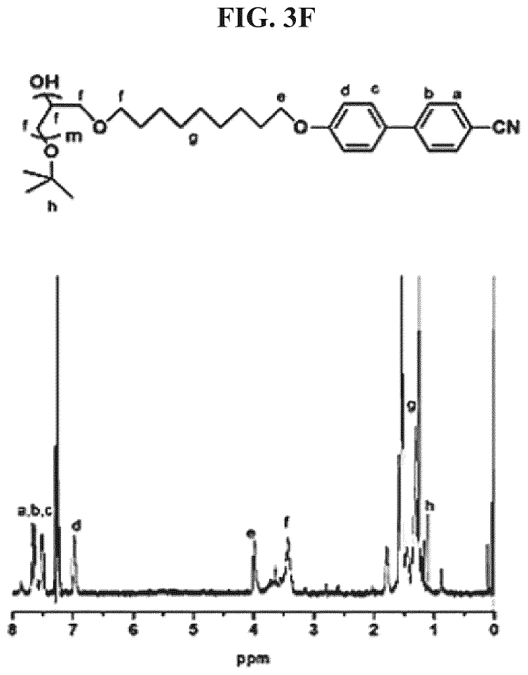

1H NMR (500 MHZ, CDCl₃): δ=7.63-7.45 (m, 6H), 6.93-6.92 (m, 2H), 3.98-3.95 (m, 2H), 3.76-3.39 (m, 7H), 1.83-1.40 (m, 4H), 1.09 (s, terminal-9H) ppm. FT-IR (ATR): 3365, 3184, 2940, 2867, 2225, 1651, 1603, 1495, 1250, 1110, 822, 770 cm⁻¹ (FIG. 3A).

B) n=5 (P-EPCN5)

The material was synthesized by the same procedure as A), except that the EPCN5 was used. The yield was 72%.

¹H NMR (500 MHZ, CDCl₃): δ=7.67-7.66 (m, 2H), 7.62-7.61 (m, 2H), 7.50-7.49 (m, 2H), 6.96-6.95 (m, 2H), 3.98-3.97 (m, 2H), 3.80-3.41 (m, 7H), 1.80-1.42 (m, 6H), 1.11 (s, terminal-9H) ppm. FT-IR (ATR): 3360, 3181, 2937, 2865, 2224, 1657, 1602, 1494, 1248, 1110, 821, 771 cm⁻¹ (FIG. 3B).

C) n=6 (P-EPCN6)

The material was synthesized by the same procedure as A), except that the EPCN6 was used. The yield was 71%.

¹H NMR (500 MHZ, CDCl₃): δ=7.66 (s, 2H), 7.62-7.61 (m, 2H), 7.50-7.49 (m, 2H), 6.96-6.95 (m, 2H), 3.98-3.97 (m), 2H), 3.77-3.41 (m, 7H), 1.80-1.42 (m, 8H), 1.11 (s, terminal-9H) ppm. FT-IR (ATR): 3362, 3176, 2935, 2863, 2224, 1656, 1603, 1495, 1250, 1111, 822, 770 cm⁻¹ (FIG. 3C).

D) n=7 (P-EPCN7)

The material was synthesized by the same procedure as A), except that the EPCN7 was used. The yield was 71%.

¹H NMR (500 MHZ, CDCl₃): δ=7.66 (s, 2H), 7.62 (s, 2H), 7.50 (s, 2H), 6.97 (s, 2H), 3.98-3.97 (m, 2H), 3.78-3.43 (m, 7H), 1.79-1.37 (m, 10H), 1.11 (s, terminal-9H) ppm. FT-IR (ATR): 3675, 3364, 3184, 2989, 2990, 2225, 1653, 1603, 1495, 1393, 1249, 1065, 822, 771 cm⁻¹ (FIG. 3D).

E) n=8 (P-EPCN8)

The material was synthesized by the same procedure as A), except that the EPCN8 was used. The yield was 71%.

¹H NMR (500 MHZ, CDCl₃): δ=7.68-7.67 (m, 2H), 7.63-7.62 (m, 2H), 7.52-7.50 (m, 2H), 6.97-6.96 (m, 2H), 3.98-3.96 (m, 2H), 3.74-3.42 (m, 7H), 1.79-1.34 (m, 12H), 1.11 (s, terminal-9H) ppm. FT-IR (ATR): 3675, 3364, 3185, 2930, 2859, 2224, 1652, 1603, 1495, 1250, 1111, 1077, 822, 770 cm⁻¹ (FIG. 3E).

F) n=9 (P-EPCN9)

The material was synthesized by the same procedure as A), except that the EPCN9 was used. The yield was 71%.

¹H NMR (500 MHZ, CDCl₃): δ=7.68-7.67 (m, 2H), 7.65-7.62 (m, 2H), 7.53-7.51 (m, 2H), 6.98-6.97 (m, 2H), 4.00-3.94 (m, 2H), 3.73-3.41 (m, 7H), 1.79-1.31 (m, 14H), 1.11 (s, terminal-9H) ppm. FT-IR (ATR): 3675, 3380, 3192, 2931, 2854, 2225, 1650, 1603, 1495, 1394, 1251, 1110, 1077, 823, 770 cm⁻¹ (FIG. 3F).

Referring to FIG. 4, which is an FT-IR (Fourier transform infrared) spectrum of P-EPCNn obtained as described above, it can be confirmed that the polyethylene glycol (PEG) backbone polymer was synthesized without any remaining epoxide moiety.

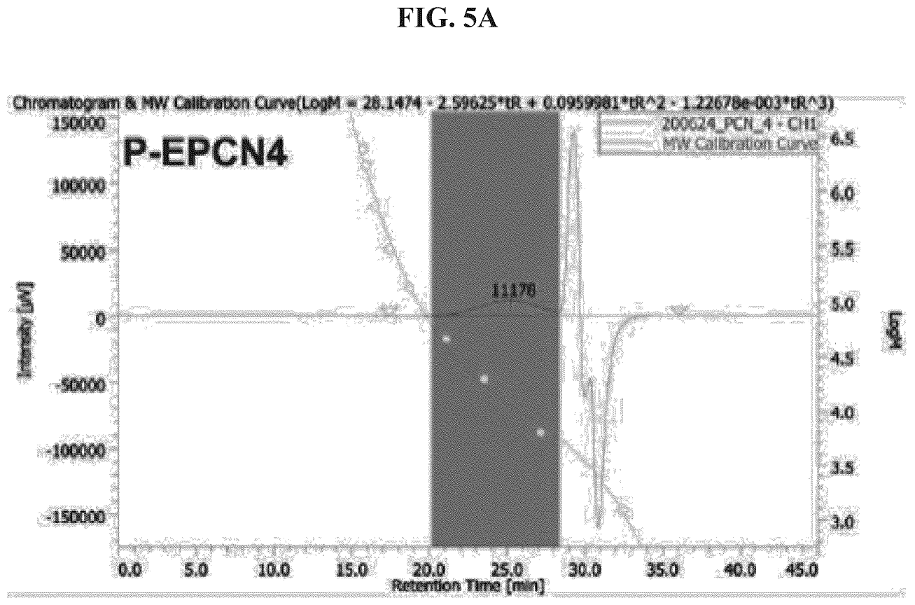

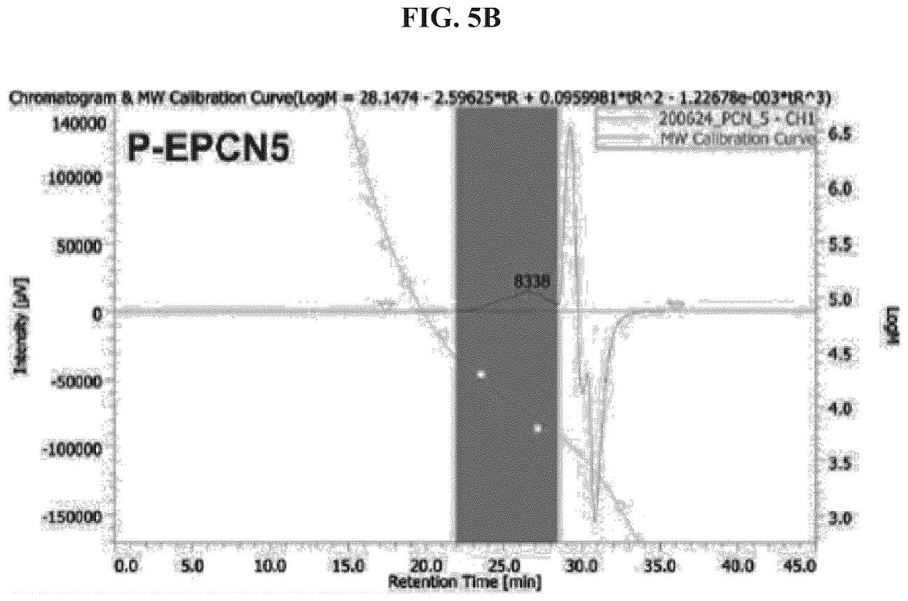

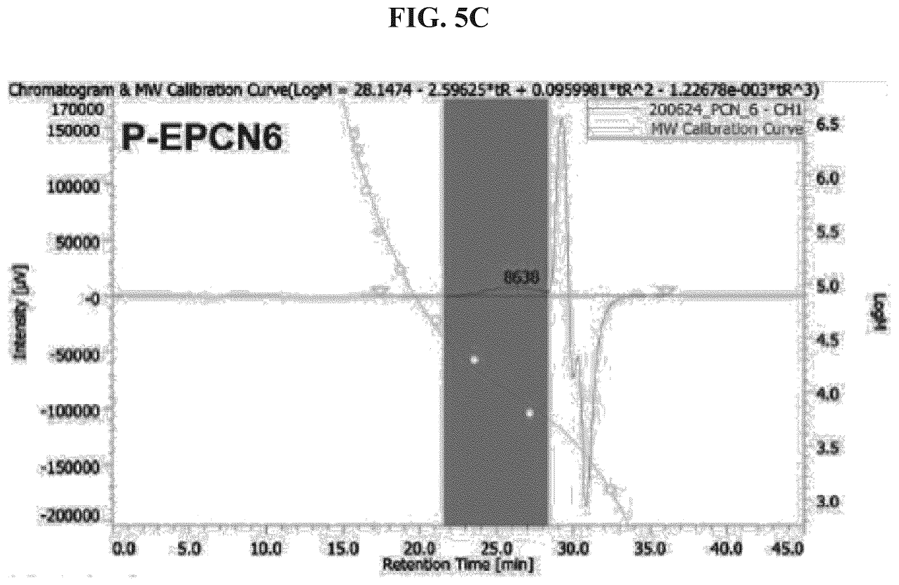

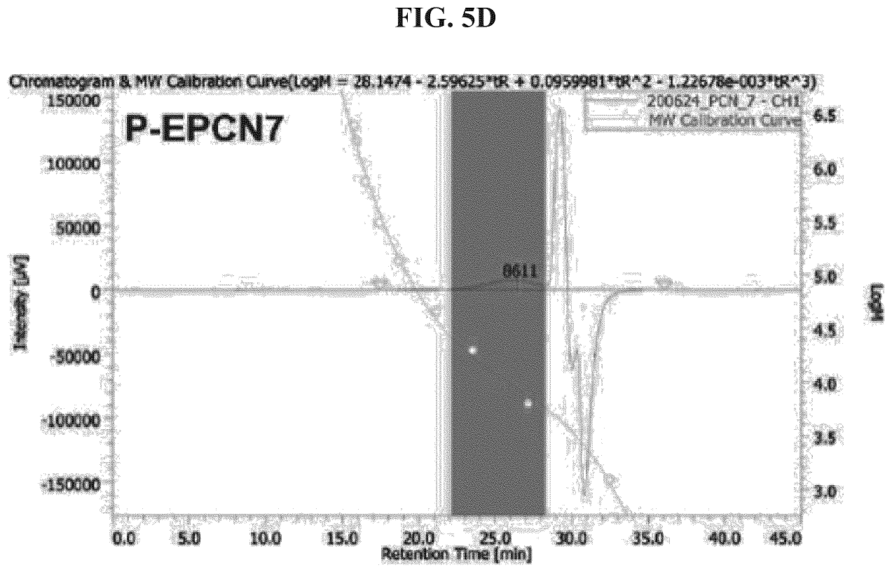

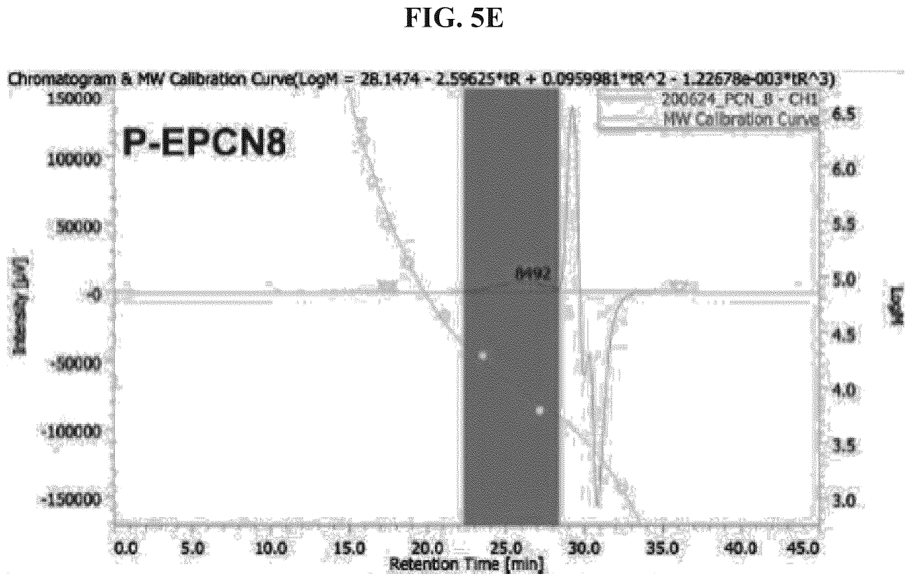

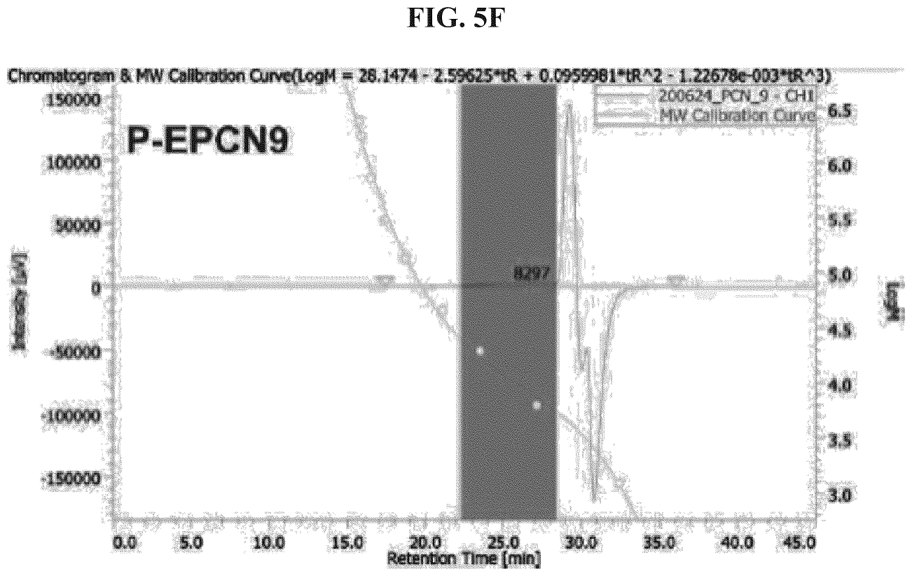

Table 1 below shows the molecular weight of P-EPCNn obtained as described above (FIGS. 5A-5F), and Table 2 below shows the physical properties of P-EPCNn.

TABLE 1

| | | P-EPCN4 | P-EPCN5 | P-EPCN6 | P-EPCN7 | P-EPCN8 | P-EPCN9 |
|---|---|---|---|---|---|---|---|
| GPC | Mn | 113 | 90 | 94 | 95 | 95 | 95 |
| (×10⁻² g/mol) | Mw | 134 | 98 | 103 | 103 | 105 | 106 |
| | PDI | 1.18 | 1.11 | 1.10 | 1.09 | 1.10 | 1.12 |

TABLE 2

| | P-EPCN4 | P-EPCN5 | P-EPCN6 | P-EPCN7 | P-EPCN8 | P-EPCN9 |
|---|---|---|---|---|---|---|
| T_{g} (° C.) | 32.6 | 16.6 | 19.5 | 17.1 | 16.3 | 16.7 |
| Tₘ (° C.) | 140.2 | 88.2 | 107.6 | 92.7 | 104.5 | 88.9 |
| Thermal | 0.32 | 0.44 | 0.42 | 0.43 | 0.46 | 0.45 |
| Conductivity | | | | | | |
| (W/m□k) | | | | | | |

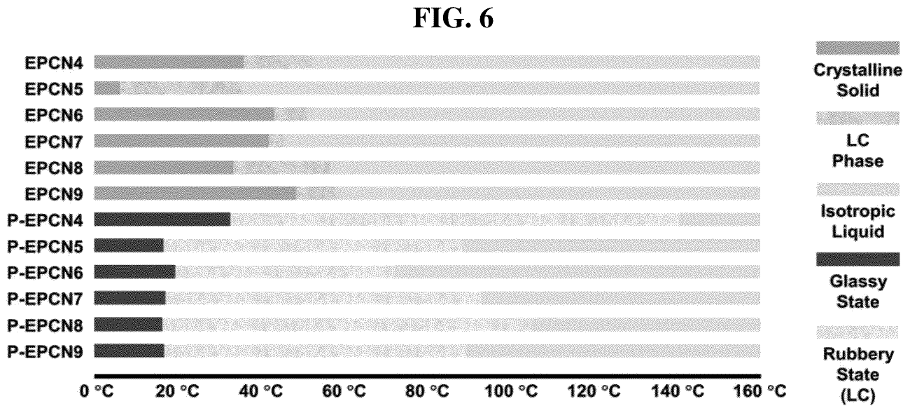

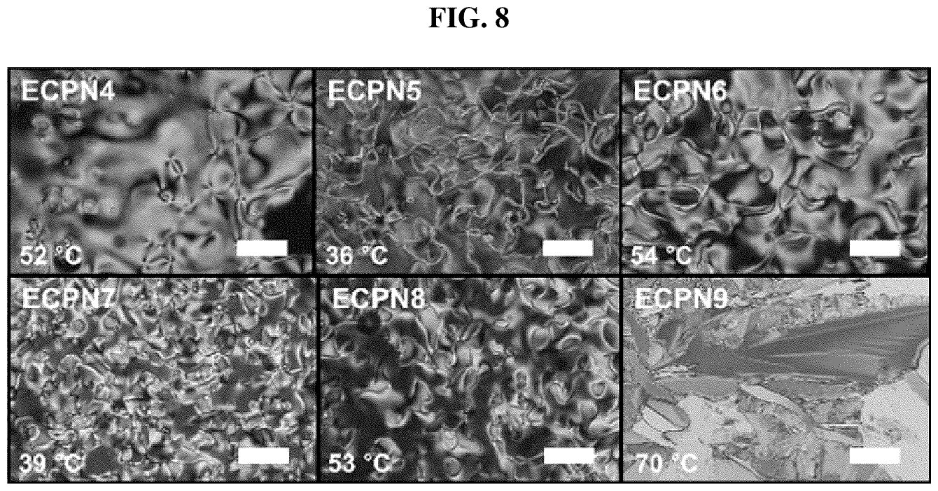

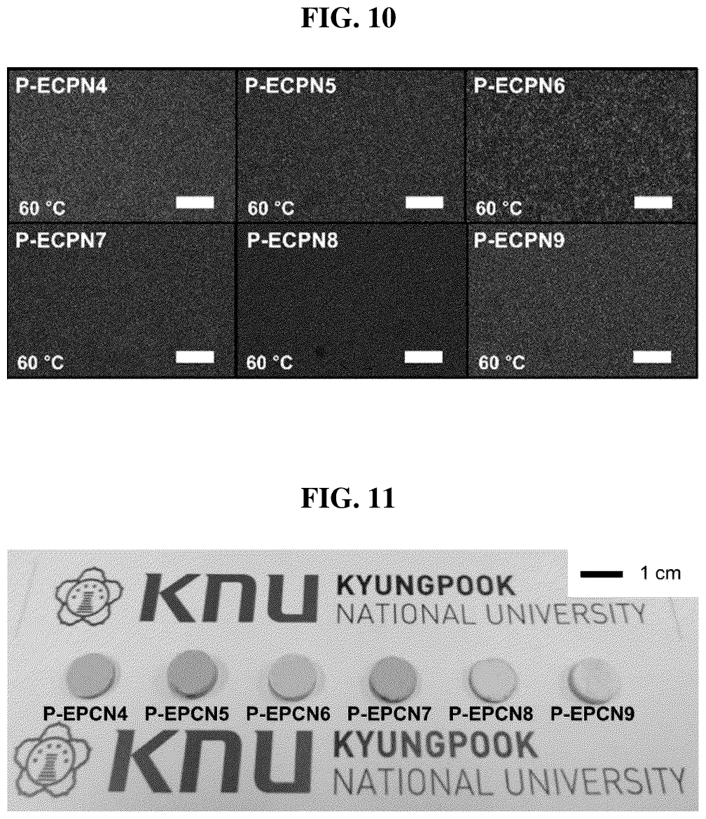

As a result of analyzing the mesophase and phase transition behavior of the material synthesized as described above through differential scanning calorimetry (DSC) and polarized optical microscopy (POM), as shown in FIGS. 6 to 10, it can be confirmed that the phase transition behavior observed in POM showed the same trend as the DSC results.

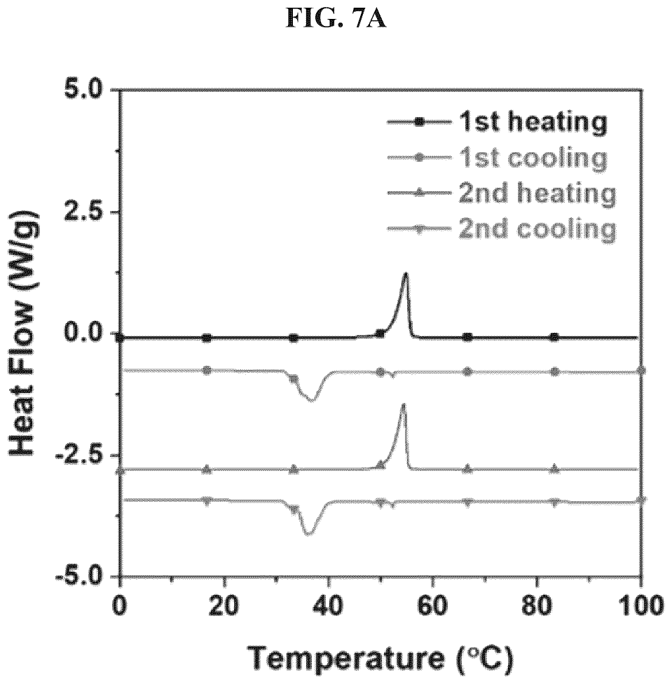

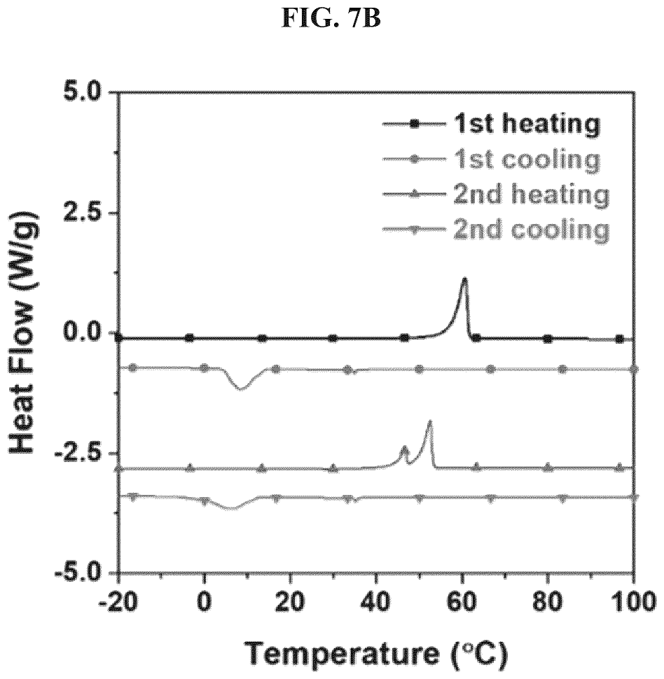

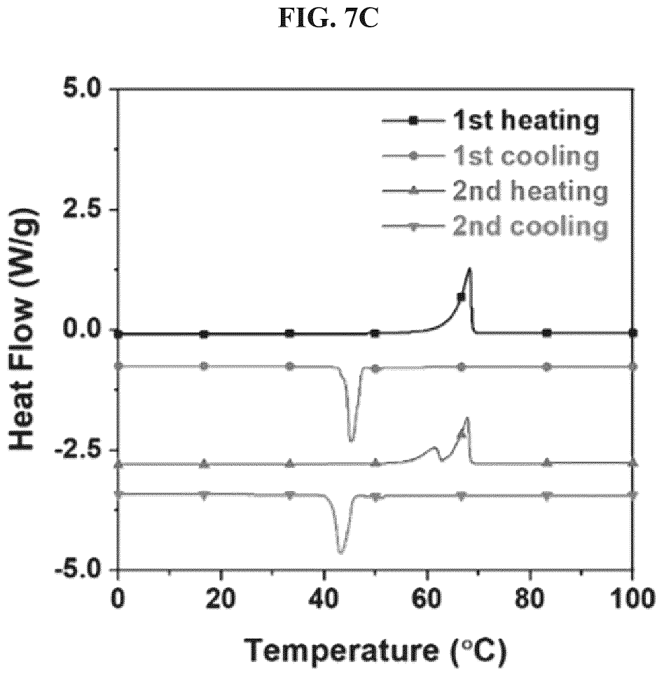

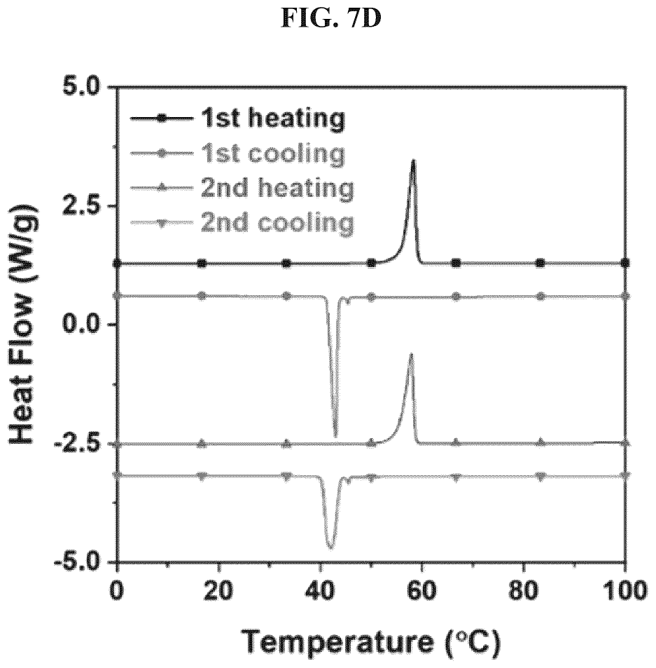

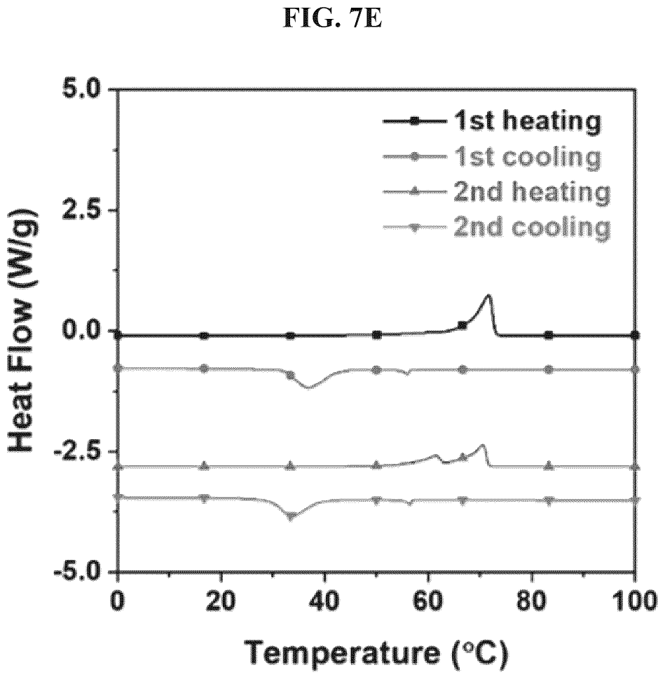

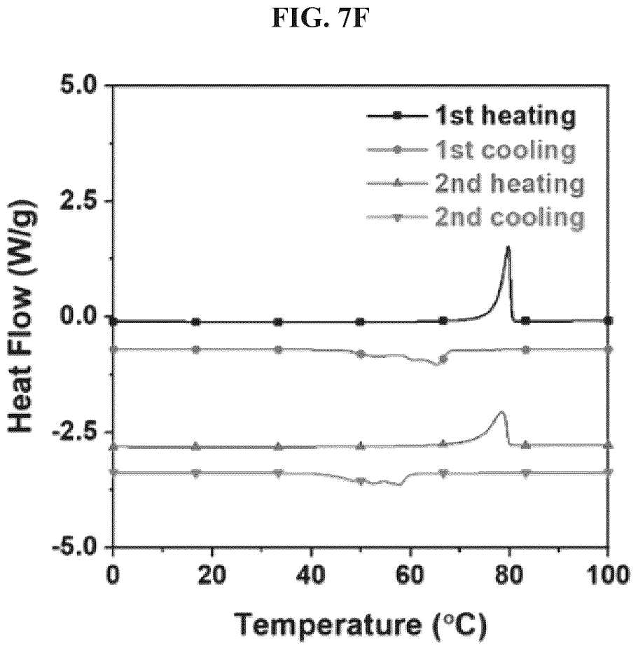

In a monomer state, the cyanobiphenyl (CB) structure, a representative thermotropic liquid crystal, formed a transparent liquid crystalline phase, but slight diversification was observed depending on the alkyl linkage length. Specifically, referring to FIGS. 7A-7F, EPCN5, EPCN6, and EPCN8 showed an enantiotropic mesophase, while EPCN4, EPCN7, and EPCN9 showed unidirectional LC during the cooling. EPCN5 showed an LC phase in a relatively wide range below room temperature, while EPCN7 showed a mesophase in a considerably narrow range above room temperature. In addition, in the POM observation, it was confirmed that the LC phase of all monomers was a transparent nematic phase. Overall, the EPCN series was a thermotropic LC having a mesophase in a range from about 40° C. to 15° C., which is slightly higher than room temperature.

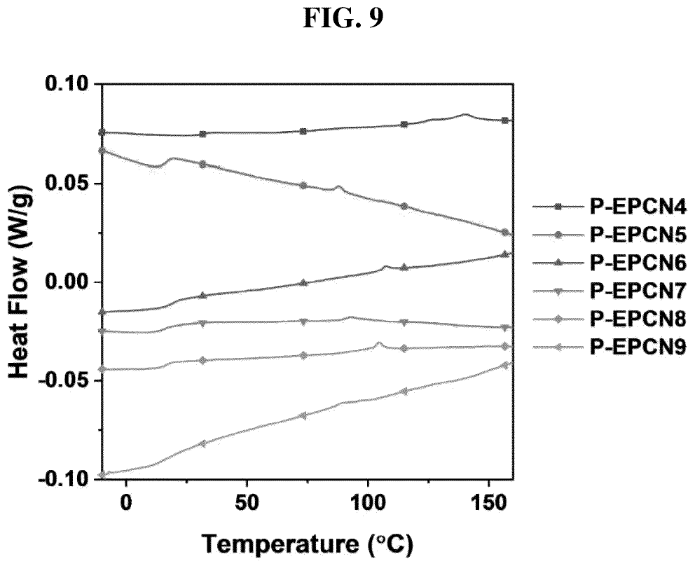

Referring to FIG. 9, it can be confirmed that P-EPCNn shows phase transition behavior that is independent of EPCNn in a polymer state. Since the PEG main chain polymer was formed while maintaining the structure of the monomer, it was expected that the structure of the polymer would have a certain tendency, but the results did not show this.

The glass transition temperature (T_{g}), except for P-EPCN4, was observed between 15° C. and 20° C., which is slightly lower than room temperature, while the T_{g} of P-EPCN4 was observed at 32.6° C., which is slightly higher than room temperature.

For the melting temperature (Tₘ), the endothermic peaks of P-EPCN5, P-EPCN7, and P-EPCN9, having an odd number of chain spacers, were observed below 100° C., while the endothermic peaks of P-EPCN4, EPCN6, and P-EPCN8, having an even number of chain spacers, were observed above 100° C.

In contrast to the glass transition behavior, a certain tendency related to an odd number-even number effect was observed in the melting behavior, which is believed to be related to the formation of alkyl spacer crystal structures.

As shown in Tables 1 and 2 above, P-EPCNn showed a distinct odd number-even number effect depending on the alkyl spacers. These results are thought to be due to the impact of the relative orientation of the mesogenic group on the change in the average shape of the side chains and the change in the equivalent weight of the spacers. For the odd-numbered members, the mesogenic units were orthogonal to the backbone, whereas for the even-numbered members, the mesogenic units were constrained to being positioned at a specific angle with respect to the backbone. Furthermore, it can be confirmed that the effect of chain length is significant in the odd-numbered members, but not for the even-numbered members. These results suggest that in the even-numbered linkers, which are constrained by the symmetry effect, the constraint by the angle is greater than the constraint by the chain length.

Overall, the phase transition temperature of P-EPCN4 was slightly higher than that of other polymers, and the behavior of other polymers was similar. This is thought to be the result of similarly controlling the molecular weight and degree of polymerization. Because P-EPCNn was a side chain liquid crystal polymer (SCLCP) rather than a main chain type, it is assumed that similar phase transition behavior was observed when the linker length allowing for interaction was secured to a certain extent. In particular, at a temperature above the Tₘ, a translucent liquid phase of a high viscosity was obtained, whereas at a temperatures below the Tₘ, an opaque solid phase was maintained.

For thermal conductivity (TC) evaluation, P-EPCNn bulk specimens were prepared through a melting process. P-EPCNn was melted at a temperature above the Tₘ of each polymer and processed into circular chips with a diameter of 1 cm. The thickness varied depending on the amount of sample, but was fixed at approximately 3 mm (FIG. 11). After polymerization, the sample color was completely white, but it changed to pale yellow after processing, which may have been due to the interaction of aromatic components. The TC value can be confirmed through Table 2 above.

Liquid crystal polymers exhibit anisotropic thermal conductivity properties due to the arrangement of their molecules in a specific direction. In particular, this molecular orientation improves heat conduction characteristics by reducing phonon scattering through the uniform arrangement in a specific direction and induces different phonon paths depending on the dimension. However, in this experiment, because P-EPCNn did not undergo a special arrangement process during the bulk material preparation, it did not show anisotropy depending on the dimension. It is expected to that anisotropy is exhibited in a microscopic scale, but isotropy is exhibited in a macroscopic level. Nevertheless, all P-EPCNn except P-EPCN4 showed significantly higher TC of 0.42-0.46 W m⁻¹K⁻¹. P-EPCN4 showed a TC of 0.32 W m⁻¹K⁻¹, which is also a high value in consideration of the PEG value. In the PEG of which main chain is similar to P-EPCNn, some changes were observed depending on the molecular weight, but the TC was approximately 0.2 to 0.3 W m⁻¹K⁻¹. Therefore, it was clear that P-EPCNn had a 2-fold higher TC due to the interaction of the cyanobiphenyl mesogen in the pendant chain.

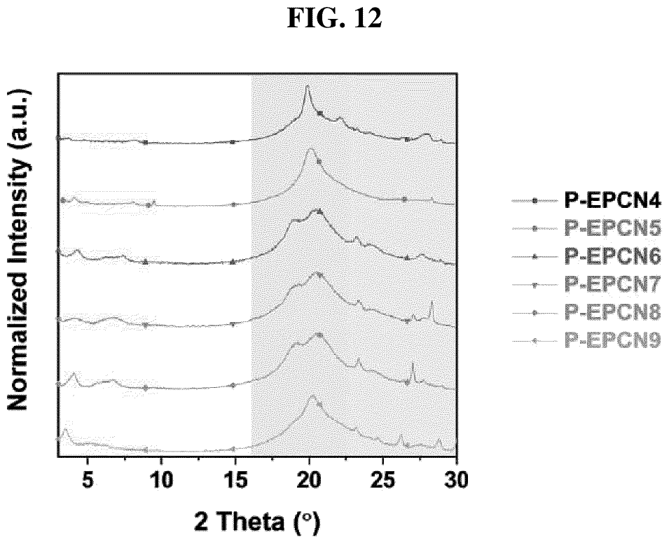

To confirm the molecular interaction, the crystal structure of the bulk specimens was analyzed through X-ray diffraction (XRD) measurement, and as a result, as shown in FIG. 12, three types of specific peaks were observed: peaks in a low angle region of the diffraction curve where 20 is less than 10° (indicated in pale yellow), peaks around 20° (indicated in light blue), and peaks above 25° (indicated in light green). Although there was a difference depending on the molecular weight, as a semi-crystalline polymer with high crystallinity, pure linear PEG showed two distinct peaks before and after 20° and several peaks above 25°, suggesting that P-EPCNn is an SCLCP with a similar backbone structure. In the case of P-EPCN6 to P-EPCN8, peaks derived from the PEG backbone was clearly identified near the region where 20=20°, and the rest showed vague but similar shapes.

However, the peak sharpness appeared different for the PEG samples, which were assumed to represent the interplanar distance of the mesogens according to the random LC arrangement. This broad peak was approximately 4-5 Å, which corresponds to the typical inter-mesogenic distance. In particular, clear evidence of mesogenic self-assembly was observed in a low-angle region below 10°. Depending on the length of the chain spacer, there was a slight difference between the peaks around 4° and 7-8°. The peaks at about 4° correspond to 20-25 Å, and the peaks at 7-8° corresponds to 11-13 Å, indicative of relatively long-range regularity.

Long-range interactions were observed from P-EPCN5 to P-EPCN9, while weak interactions were observed from P-EPCN4, which exhibited an LC phase at room temperature. As a result, the arrangement quality of P-EPCN4 was degraded by the interaction, and its thermal conductivity was lower than that of other samples. In addition, regarding the LC phase of P-EPCNn, it was confirmed through optical observation that all P-EPCNn had a nematic phase, but it was inferred through the structural analysis that P-EPCN5 to P-EPCN9 had a relatively strong order at room temperature, though not being a smectic phase.

In addition, the XRD results confirmed that P-EPCN5 to P-EPCN9 exhibited similar molecular arrangement levels and that they also showed a similar trend in TC. Meanwhile, P-EPCN4, which showed a difference in the molecular arrangement level in XRD, exhibited a large difference in TC. These results show that the molecular arrangement level in the polymer network has a significant impact on the TC value.

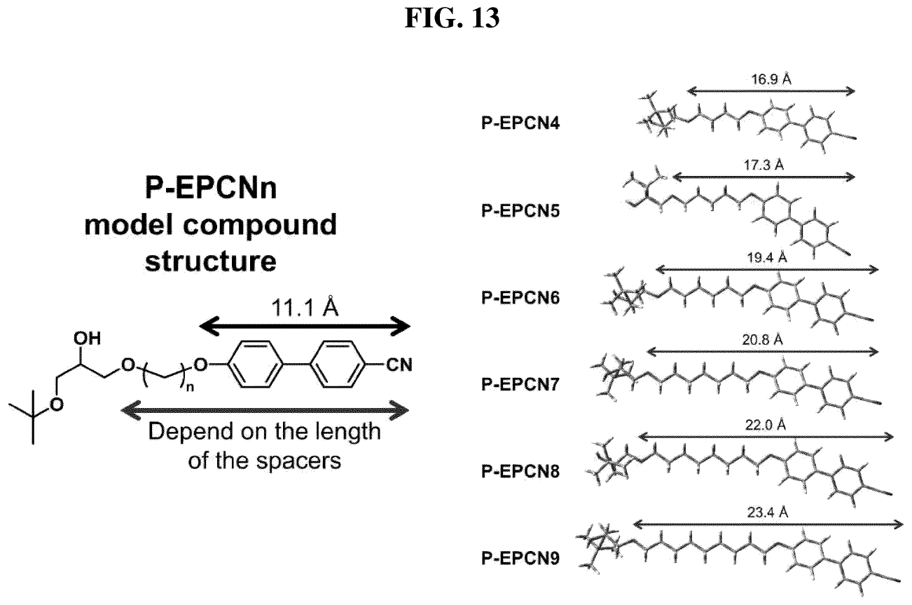

As shown in FIG. 13, the optimized molecular structure of the P-EPCNn model compound calculated by the density functional theory (DFT) at the B3LYP/6-31G level showed that the long axis length of the CB molecule of P-EPCNn was about 11 Å, corresponding to the peak found in the 7-8° region. In addition, the long axis length of the entire side chain obtained from the same DFT calculation results was 17 Å in P-EPCN4 and 23 Å in P-EPCN9, and the regularity of the pendant groups was confirmed around 4°. Although it is difficult to consider that P-EPCNn has high crystallinity because the peak is not clear, considering that they are polymeric materials, P-EPCNn has a sufficiently high level of crystal structure derived from mesogenic self-assembly.

Furthermore, the reason why low TC was observed in P-EPCN4 unlike other P-EPCNn, can be confirmed from the correlation between the crystal structure and TC. Unlike other P-EPCNn, almost no peak was observed in the low-angle region of P-EPCN4, indicating that mesogenic self-assembly did not occur sufficiently, which is the reason for the low TC of P-EPCN4.

In addition, the mesogen of P-EPCN4, which is positioned through four carbon alkyl bonds from the main chain, made it difficult to secure a sufficient distance for interaction, unlike other P-EPCNn with long spacers. Moreover, due to the room temperature glassy phase, P-EPCNn, except for P-EPCN4, may be formed into an LC phase in the rubbery region at room temperature. This resulted in low crystallinity and TC of P-EPCN4. On the contrary, P-EPCNn exhibits an LC phase at room temperature and has a high TC.

### <Example 3> OMPBn: Synthesis of 4-(oxiran-2-ylmethoxy)phenyl 4-butoxybenzoate monomer

Scheme 3 below shows the synthesis process of the epoxide monomer OMPBn, which has phenyl benzoate, a thermotropic liquid crystal structure, in a side chain, wherein 4-(alkoxy) benzoic acid was used as a starting material to synthesize HPBn through a reaction with hydroquinone, and then OMPBn was obtained through a reaction with epichlorohydrin.

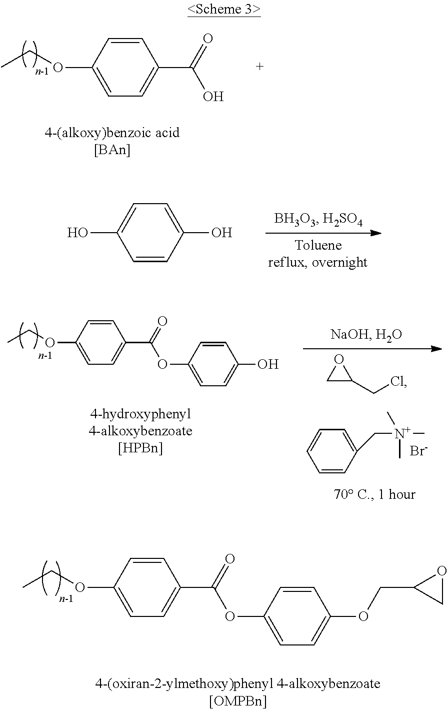

### \textcircled{1} HPBn: Synthesis of 4-hydroxyphenyl 4-alkoxybenzoate

A) n=4 (HPB4)

4-butoxybenzoic acid (3.00 g, 15.4 mmol), hydroquinone (6.80 g, 61.7 mmol), and BH303 (0.0318 g) were added to a three-necked round flask, of which atmosphere was replaced with argon. Afterwards, 120 ml of toluene and 0.1 ml of sulfuric acid were added, and the resulting mixture was stirred at 130° C. for 12 hours. The obtained solution was concentrated by using a rotary evaporator and then the organic matter was extracted with diethyl ether. The organic phase was dried with magnesium sulfate and purified through silica column chromatography using a solution containing hexane and ethyl acetate in a volume ratio of 7:1 as an eluent. The yield was 24%.

¹H NMR (500 MHZ, CDCl₃): δ=8.13 (d, J=9.0 Hz, 2H), 7.06 (d, J=9.0 Hz, 2H), 6.97 (d, J=8.5 Hz, 2H), 6.85 (d), J=9.0 Hz, 2H), 4.87 (s, 1H), 4.06 (t, J=6.5 Hz, 2H), 1.84-1.78 (m, 2H), 1.54-1.48 (m, 2H), 1.00 (t, J=7.5 Hz, 3H) ppm.

B) n=6 (HPB6)

The material was synthesized by the same procedure as A), except that 4-(hexyloxy)benzoic acid was used instead of 4-butoxybenzoic acid. The yield was 58%.

¹H NMR (500 MHZ, CDCl₃): δ=8.13 (d, J=9.0 Hz, 2H), 7.07 (d, J=9.0 Hz, 2H), 6.97 (d, J=9.0 Hz, 2H), 6.86 (d), J=9.0 Hz, 2H), 4.87 (s, 1H), 4.05 (t, J=6.5 Hz, 2H), 1.85-1.79 (m, 2H), 1.52-1.45 (m, 2H), 1.37-1.34 (m, 4H), 0.93 (t, J=7.0 Hz, 3H) ppm.

C) n=8 (HPB8)

The material was synthesized by the same procedure as A), except that 4-(octyloxy)benzoic acid was used instead of 4-butoxybenzoic acid. The yield was 57%.

¹H NMR (500 MHZ, CDCl₃): δ=8.13 (d, J=9.0 Hz, 2H), 7.07 (d, J=9.0 Hz, 2H), 6.97 (d, J=9.0 Hz, 2H), 6.86 (d, J=9.0 Hz, 2H), 4.88 (s, 1H), 4.05 (t, J=6.5 Hz, 2H), 1.86-1.79 (m, 2H), 1.50-1.44 (m, 2H), 1.38-1.29 (m, 8H), 0.91 (t, J=7.0 Hz, 3H) ppm.

D) n=10 (HPB10)

The material was synthesized by the same procedure as A), except that 4-(decyloxy)benzoic acid was used instead of 4-butoxybenzoic acid. The yield was 59%.

¹H NMR (500 MHZ, CDCl₃): δ=8.13 (d, J=9.0 Hz, 2H), 7.07 (d, J=8.5 Hz, 2H), 6.97 (d, J=8.5 Hz, 2H), 6.86 (d), J=9.0 Hz, 2H), 4.80 (s, 1H), 4.05 (t, J=6.5 Hz, 2H), 1.85-1.79 (m, 2H), 1.51-1.44 (m, 2H), 1.38-1.27 (m, 10H), 0.90 (t, J=7.0 Hz, 3H) ppm.

### \textcircled{2} Synthesis of OMPBn (4-(oxiran-2-ylmethoxy)phenyl 4-alkoxybenzoate)

E) n=4 (OMPB4)

4-hydroxyphenyl 4-butoxybenzoate (HPB4) (0.50 g, 1.74 mmol), NaOH (0.0701 g, 1.74 mmol), and benzyl trimethyl ammonium bromide (0.401 g, 1.74 mmol) were put into a three-necked flask, of which atmosphere was replaced with argon. Afterwards, 10 ml of epichlorohydrin and 1 ml of water were added, and the resulting mixture was stirred at 70° C. for 1 hour. After removing the solvent, the obtained solution was purified through silica column chromatography using a solution containing hexane and ethyl acetate in a volume ratio of 5:1 as an eluent. The yield was 29%.

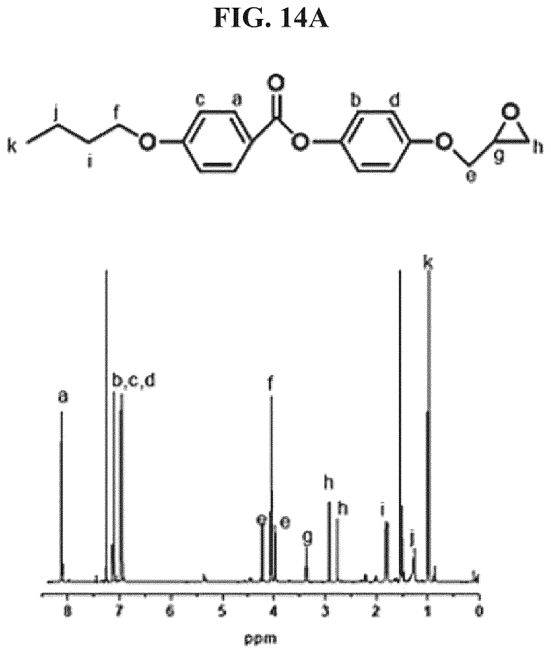

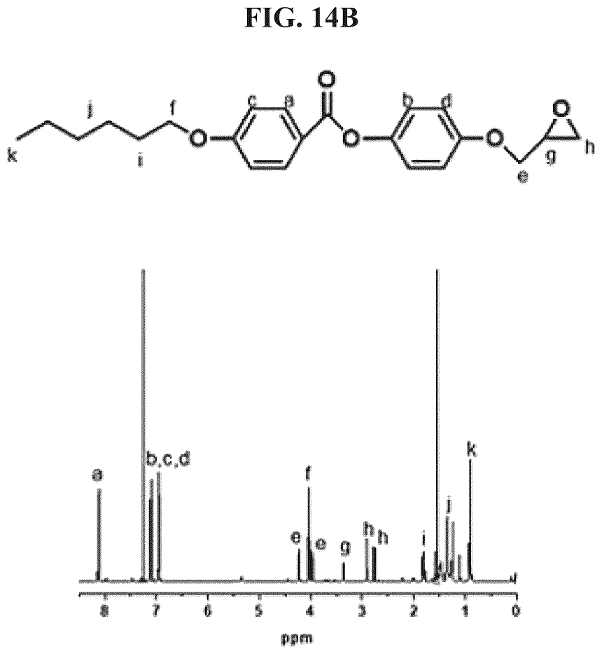

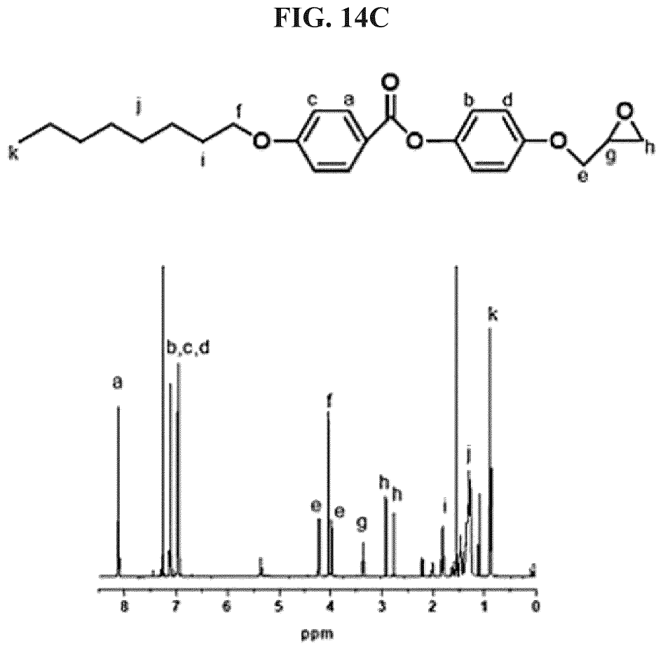

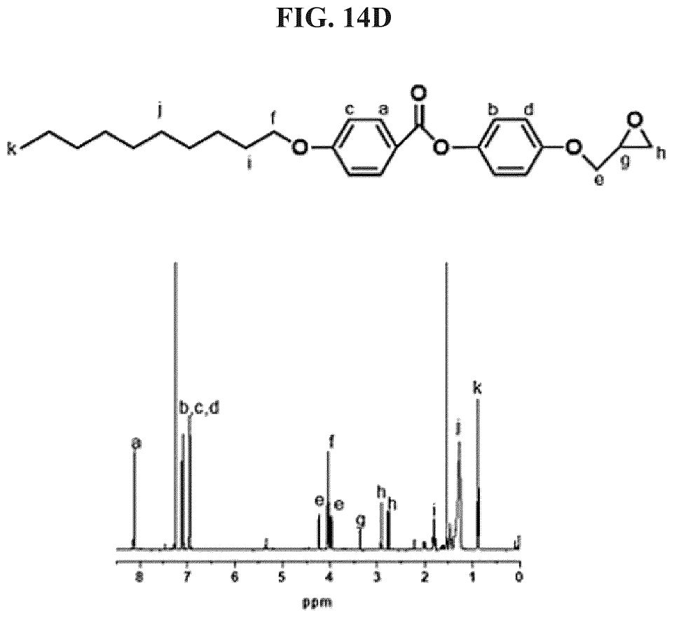

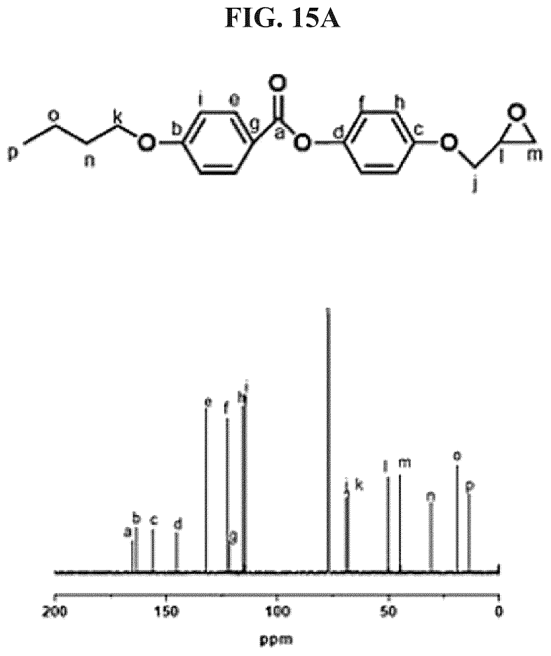

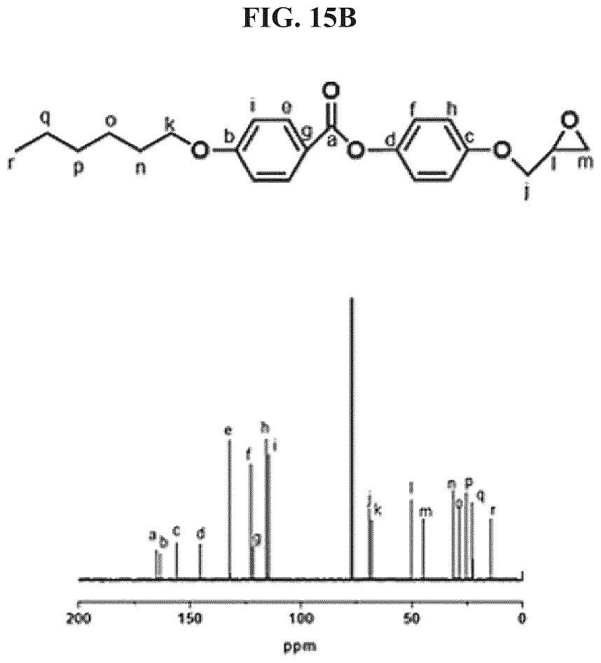

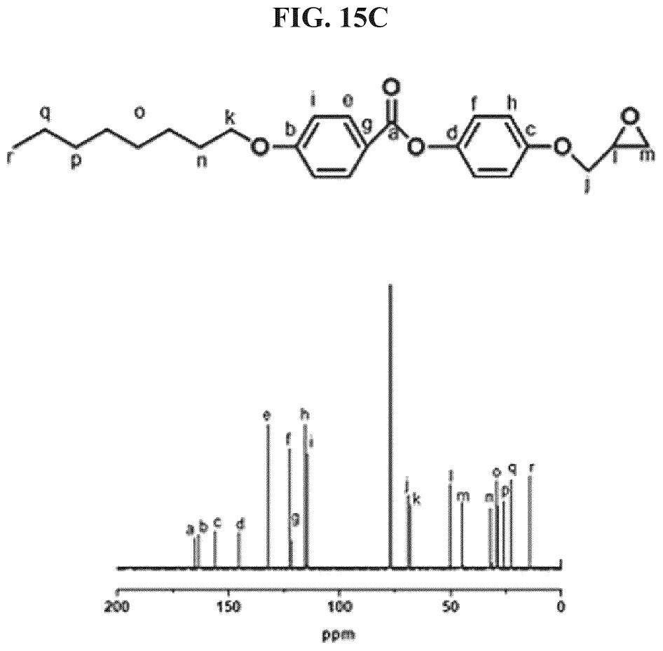

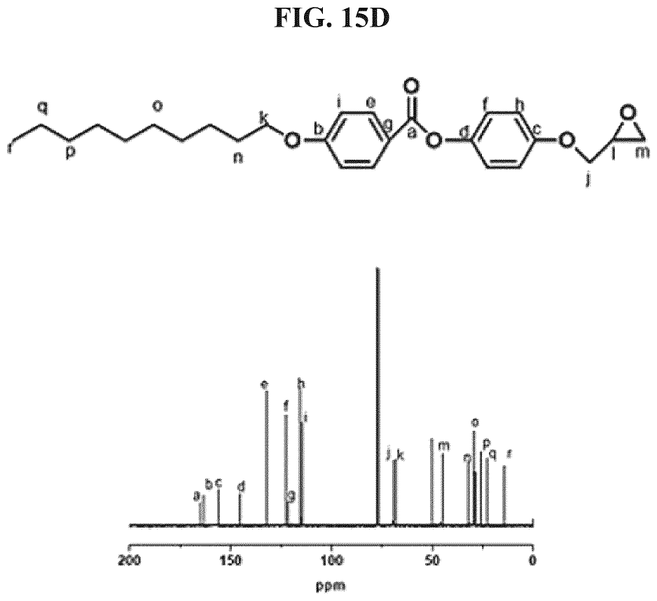

¹H NMR (500 MHZ, CDCl₃): δ=8.13 (d, J=9.0 Hz, 2H), 7.10 (d, J=9.5 Hz, 2H), 6.97 (d, J=9.0 Hz, 2H), 6.95 (d), J=9.0 Hz, 2H), 4.22 (dd, J=11, 3.0 Hz, 1H), 4.05 (t, J=6.5 Hz, 2H), 3.98 (dd, J=11, 5.5 Hz, 1H), 3.38-3.35 (m, 1H), 2.91 (dd, J=5.0, 4.5 Hz, 1H), 2.77 (dd, J=5.0, 2.5 Hz, 1H), 1.84-1.78 (m, 2H), 1.53-1.48 (m, 2H), 0.99 (t, J=7.0 Hz, 3H) ppm. ¹³C (125 MHZ, CDCl₃): δ=165.3, 163.5, 156.1, 145.0, 132.2, 122.6, 121.6, 115.3, 114.3, 69.2, 68.0, 50.1, 44.7, 31.1, 19.2, 13.8 ppm. HRMS (+EI): calcd for [C₂₀H₂₂O₅]⁺: 342.1467; found: 342.1467 (FIG. 14A and FIG. 15A).

F) n=6 (OMPB6)

The material was synthesized by the same procedure as E), except that the HPB6 was used. The yield was 40%.

¹H NMR (500 MHZ, CDCl₃): δ=8.11 (d, J=9.0 Hz, 2H), 7.10 (d, J=9.0 Hz, 2H), 6.97 (d, J=9.0 Hz, 2H), 6.95 (d), J=9.0 Hz, 2H), 4.22 (dd, J=11, 3.0 Hz, 1H), 4.04 (t, J=6.5 Hz, 2H), 3.97 (dd, J=11, 5.5 Hz, 1H), 3.38-3.35 (m, 1H), 2.91 (dd, J=5.0, 4.5 Hz, 1H), 2.77 (dd, J=5.0, 2.5 Hz, 1H), 1.85-1.79 (m, 2H), 1.52-1.45 (m, 2H), 1.37-1.34 (m, 4H), 0.91 (t, J=7.0 Hz, 3H) ppm. ¹³C (125 MHZ, CDCl₃): δ=165.3, 163.5, 156.1, 145.0, 132.2, 122.6, 121.6, 115.3, 114.3, 69.3, 68.3, 50.1, 44.7, 31.6, 29.1, 25.7, 22.6, 14.0 ppm. HRMS (+EI): calcd for [C₂₂H₂₆O₅]⁺: 370.1780; found: 370.1779 (FIG. 14B and FIG. 15B).

G) n=8 (OMPB8)

The material was synthesized by the same procedure as E), except that the HPB8 was used. The yield was 35%.

¹H NMR (500 MHZ, CDCl₃): δ=8.11 (d, J=9.0 Hz, 2H), 7.10 (d, J=9.5 Hz, 2H), 6.97 (d, J=9.0 Hz, 2H), 6.95 (d), J=9.0 Hz, 2H), 4.22 (dd, J=11, 3.0 Hz, 1H), 4.04 (t, J=6.5 Hz, 2H), 3.97 (dd, J=11, 5.5 Hz, 1H), 3.38-3.34 (m, 1H), 2.91 (dd, J=5.0, 4.5 Hz, 1H), 2.77 (dd, J=5.0, 2.5 Hz, 1H), 1.85-1.79 (m, 2H), 1.50-1.44 (m, 2H), 1.38-1.29 (m, 8H), 0.89 (t, J=7.0 Hz, 3H) ppm. ¹³C (125 MHZ, CDCl₃): δ=165.3, 163.5, 156.1, 145.0, 132.2, 122.6, 121.6, 115.3, 114.3, 69.3, 68.3, 50.1, 44.7, 31.8, 29.3, 29.2, 29.1, 26.0 25.7, 14.1 ppm. HRMS (+EI): calcd for [C₂₄H₃₀O₅]⁺: 398.2093; found: 398.2094 (FIG. 14C and FIG. 15C).

H) n=10 (OMPB10)

The material was synthesized by the same procedure as E), except that the HPB10 was used. The yield was 36%.

¹H NMR (500 MHZ, CDCl₃): δ=8.11 (d, J=9.0 Hz, 2H), 7.10 (d, J=9.0 Hz, 2H), 6.97 (d, J=8.5 Hz, 2H), 6.95 (d), J=9.0 Hz, 2H), 4.22 (dd, J=11, 3.0 Hz, 1H), 4.04 (t, J=6.5 Hz, 2H), 3.97 (dd, J=11, 5.5 Hz, 1H), 3.39-3.35 (m, 1H), 2.91 (dd, J=5.0, 4.5 Hz, 1H), 2.77 (dd, J=5.0, 2.5 Hz, 1H), 1.85-1.79 (m, 2H), 1.50-1.44 (m, 2H), 1.39-1.28 (m, 12H), 0.88 (t, J=7.0 Hz, 3H) ppm. ¹³C (125 MHZ, CDCl₃): δ=165.3, 163.5, 156.1, 145.0, 132.2, 122.7, 121.6, 115.4, 114.3, 69.3, 68.3, 50.1, 44.7, 31.9, 29.6, 29.6, 29.4, 29.3, 29.1, 26.0, 25.7, 14.1 ppm. HRMS (+EI): calcd for [C₂₆H₃₄O₅]⁺: 426.2406; found: 426.2409 (FIG. 14D and FIG. 15D).

### <Example 4> Synthesis of OMPBn Polymer (P-OMPBn)

Scheme 4 below shows the synthesis process of P-OMPBn, a polyethylene glycol derivative having phenyl benzoate, a liquid crystal structure, in a side chain. As shown in Scheme 4 below, the synthesis was performed through ring-opening polymerization of the epoxide monomer OMPBn to form the polyethylene glycol main chain.

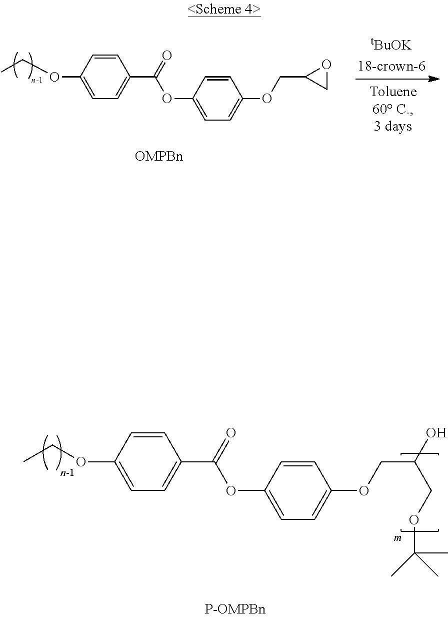

A) n=4 (P-OMPB4)

OMPB4 (0.300 g, 0.876 mmol), potassium tert-butoxide (39.0 mg, 327 μmol), and 18-Crown-6 (18.0 mg, 65.0 μmol) were put into a Schlenk tube, of which atmosphere was replaced with argon. Afterwards, 3 ml of toluene was added, and the resulting mixture was stirred at room temperature for 3 days to perform polymerization. Thereafter, the polymerization solution was precipitated in 50 ml of methanol, and the precipitate was recovered. The precipitation process was repeated twice, and a brown solid was obtained with a yield of 81%.

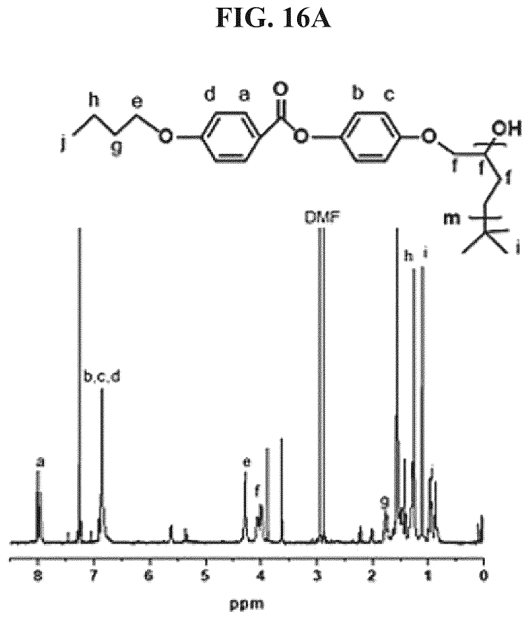

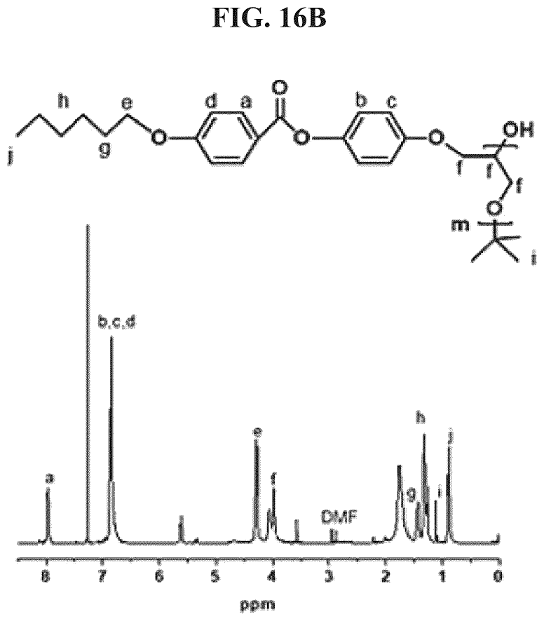

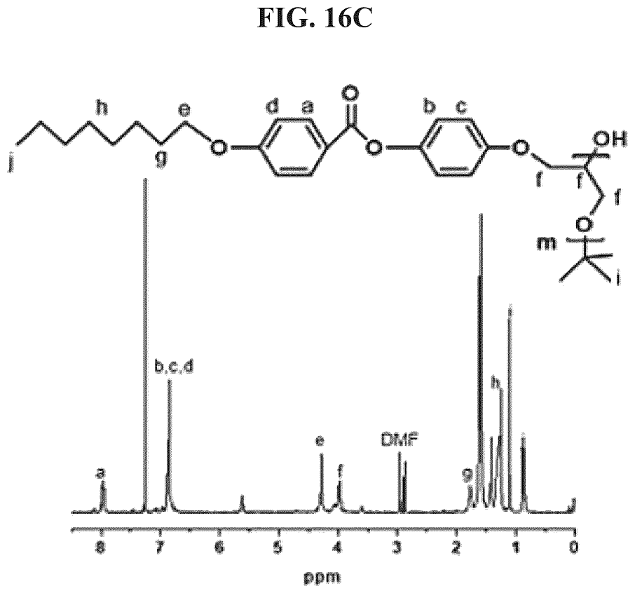

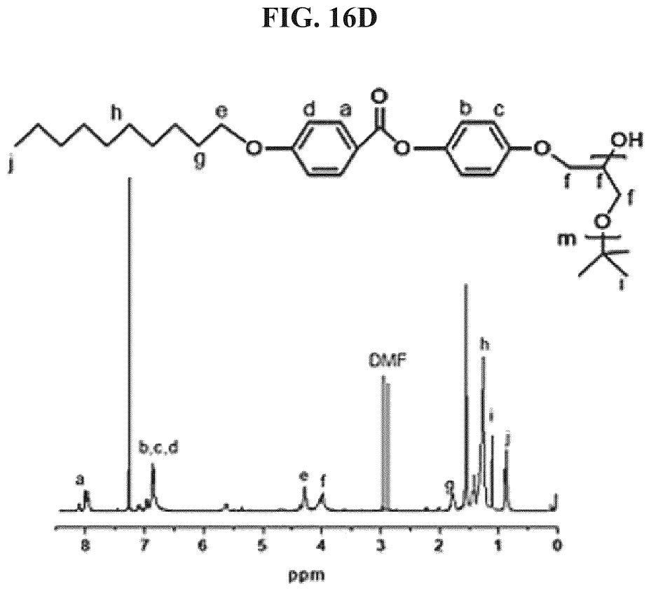

¹H NMR (500 MHZ, CDCl₃): δ=8.02-7.96 (m, 2H), 6.91-6.82 (m, 6H), 4.29-4.28 (m, 2H), 4.08-3.64 (m, 5H), 1.81-1.26 (m, 4H), 1.11 (s, 9H), 0.10-0.81 (m, 3H) ppm (FIG. 16A).

B) n=6 (P-OMPB6)

The material was synthesized by the same procedure as A), except that the OMPB6 was used. The yield was 82%. 1H NMR (500 MHZ, CDCl₃): δ=8.02-7.96 (m, 2H), 6.91-6.82 (m, 6H), 4.29-4.28 (m, 2H), 4.08-3.63 (m, 5H), 1.82-1.26 (m, 8H), 1.11 (s, 9H), 0.10-0.81 (m, 3H) ppm (FIG. 16B).

C) n=8 (P-OMPB8)

The material was synthesized by the same procedure as A), except that the OMPB8 was used. The yield was 82%.

¹H NMR (500 MHZ, CDCl₃): δ=8.02-7.96 (m, 2H), 6.91-6.82 (m, 6H), 4.29-4.28 (m, 2H), 4.08-3.63 (m, 5H), 1.82-1.26 (m, 8H), 1.11 (s, 9H), 0.10-0.81 (m, 3H) ppm (FIG. 16C).

D) n=10 (P-OMPB10)

The material was synthesized by the same procedure as A), except that the OMPB10 was used. The yield was 92%.

¹H NMR (500 MHZ, CDCl₃): δ=8.02-7.94 (m, 2H), 7.12-6.86 (m, 6H), 4.37-4.28 (m, 2H), 4.05-3.97 (m, 5H), 1.82-1.26 (m, 16H), 1.11 (s, 9H), 0.89-0.87 (m, 3H) ppm (FIG. 16D).

Table 3 below shows the molecular weight of P-OMPBn obtained as described above, and Table 4 below shows the physical properties 5 of P-OMPBn.

TABLE 3

| | | P-OMPB4 | P-OMPB6 | P-OMPB8 | P-OMPB10 |
|---|---|---|---|---|---|
| GPC | Mn | 157 | 134 | 112 | 62 |
| (×10⁻³ g/mol) | Mw | 440 | 445 | 474 | 169 |
| | PDI | 2.78 | 3.31 | 4.23 | 2.75 |

TABLE 4

| | P-OMPB4 | P-OMPB6 | P-OMPB8 | P-OMPB10 |
|---|---|---|---|---|
| T_{g} (° C.) | 55 | 43 | 22 | 33 |
| Tₘ (° C.) | 182 | 139 | 110 | 153 |
| Thermal | 0.43 | 0.44 | 0.37 | 0.40 |
| Conductivity | | | | |
| (W/m□k) | | | | |

In the foregoing, specific aspects of the present invention have been described in detail above, but it is clear to those skilled in the art that these specific technologies are merely preferred implementation examples and do not limit the scope of the present invention. Accordingly, the substantial scope of the present invention will be defined by the appended claims and their equivalents. The scope of the present invention is indicated by the claims described below, and all changes or modified forms derived from the meaning and scope of the claims and their equivalent concepts should be construed as being included in the scope of the present invention.

1. A compound having a thermotropic liquid crystal structure in a side chain, represented by Formula (I) below: 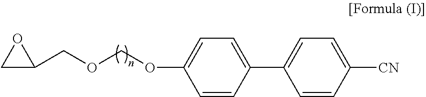
[In the formula, n is an integer in a range from 1 to 30.]

2. A compound having a thermotropic liquid crystal structure in a side chain, represented by Formula (II) below: 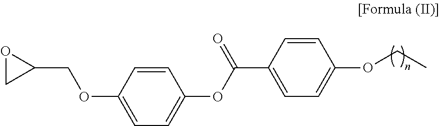
[In the formula, n is an integer in a range from 1 to 30.]

3. A polyethylene glycol polymer obtained by ring-opening polymerization of a compound according to claim 1.

4. A polyethylene glycol polymer obtained by ring-opening polymerization of a compound according to claim 2.

5. A polyethylene glycol polymer represented by Formula (III) below and obtained by ring-opening polymerization of a compound according to claim 1: 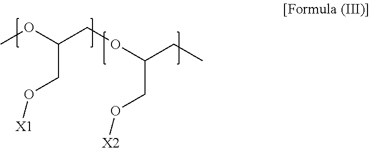
[In the formula, X1 and X2 may be the same or different and are selected from the compound according to claim 1.

6. The polyethylene glycol polymer according to claim 1, wherein the polyethylene glycol polymer is used in substrates, compounds, adhesives, pads, heat spreads, and heat sinks.

7. A polyethylene glycol polymer represented by Formula (III) below and obtained by ring-opening polymerization of a compound according to claim 2: 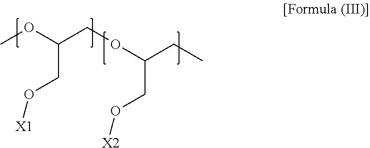
[In the formula, X1 and X2 may be the same or different and are selected from the compound according to claim 2].

8. The polyethylene glycol polymer according to claim 2, wherein the polyethylene glycol polymer is used in substrates, compounds, adhesives, pads, heat spreads, and heat sinks.
